(19) United States
(12) Patent Application Publication
(10) Pub. No.: US 2026/0067760 A1
(43) Pub. Date: Mar. 5, 2026

(54) SUCCESSFUL PSCELL REPORT NETWORK SIGNALING

(71) Applicant: Telefonaktiebolaget LM Ericsson (publ), Stockholm (SE)

(72) Inventors: Julien MULLER, Rennes (FR); Tahmineh TORABIAN ESFAHANI, Sollentuna (SE); Ali PARICHEHREHTEROUJENI, Linköping (SE); Sakib BIN REDHWAN, Linköping (SE)

(21) Appl. No.: 19/101,564

(22) PCT Filed: Aug. 7, 2023
(86) PCT No.: PCT/SE2023/050785

§ 371 Date: Feb. 5, 2025

Related U.S. Application Data
(60) Provisional application No. 63/396,059, filed on Aug. 8, 2022.

(51) Int. Cl. H04W 36/00

(52) U.S. Cl. CPC H04W 36/0058

(57) ABSTRACT

A method is provided performed by a first network node to identify a network node that initiated a PSCell change that results in generation of a report from a UE. The method includes signaling a request including a request for a PSCell change including a PSCell addition or a SN addition and a first indication related to the PSCell change. The first indication indicates that the PSCell change is related to one of a first or second network node initiating the PSCell change. The method further includes receiving a message including the report; and performing, based on the first indication, one of: (i) if the PSCell change was initiated by the first network node, analyzing the report to improve the PSCell change, and (ii) if the PSCell change was initiated by the second network node, forwarding the report to at least one additional network node.

### TECHNICAL FIELD

The present disclosure relates generally to wireless communications, and more particularly to communication methods and related devices and nodes supporting wireless communications.

### BACKGROUND

FIG. 1 illustrates a wireless communication system in third generation partnership project (3GPP).

In the wireless communication system 100 illustrated in FIG. 1, a UE 102 communicates with one or multiple access nodes 103-104, which in turn is connected to a network node 106. The access nodes 103-104 are part of the radio access network 100.

For wireless communication systems pursuant to 3GPP Evolved Packet System, EPS (also referred to as Long Term Evolution (LTE), or fourth generation (4G)) standard specifications, such as specified in 3GPP TS 36.300 V17.1.0 and related specifications, the access nodes 103-104 typically correspond to an Evolved NodeB (eNB) and the network node 106 typically corresponds to either a Mobility Management Entity (MME) and/or a Serving Gateway (SGW). The eNB is part of the radio access network 100, which in this case is the E-UTRAN (Evolved Universal Terrestrial Radio Access Network), while the MME and SGW are both part of the EPC (Evolved Packet Core network). The eNBs are inter-connected via the X2 interface, and connected to EPC via the S1 interface, more specifically via S1-C to the MME and S1-U to the SGW.

For wireless communication systems pursuant to a 3GPP fifth generation (5G) System (5GS) (also referred to as New Radio (NR) or 5G) standard specifications, such as specified in 3GPP TS 38.300 V17.1.0 and related specifications, on the other hand, the access nodes 103-104 typically corresponds to an 5G NodeB (gNodeB (gNB)) and the network node 106 typically corresponds to either an Access and Mobility Management Function (AMF) and/or a User Plane Function (UPF). The gNB is part of the radio access network 100, which in this case is the NG-RAN (Next Generation Radio Access Network), while the AMF and UPF are both part of the 5G Core Network (5GC). The gNBs are inter-connected via the Xn interface, and connected to 5GC via the NG interface, more specifically via NG-C to the AMF and NG-U to the UPF.

To support fast mobility between NR and LTE and avoid change of core network, LTE eNBs can also be connected to the 5G-CN via NG-U/NG-C and support the Xn interface. An eNB connected to 5GC may be called a next generation eNB (ng-eNB) and is considered part of the NG-RAN. Operations of the present disclosure described for LTE and NR may also apply to LTE connected to 5GC. When the term “LTE” is used herein without further specification, the term refers to LTE-EPC.

A Self-Organizing Network (SON) in, e.g., 3GPP, is an automation technology designed to make the planning, configuration, management, optimization and healing of mobile radio access networks simpler and faster. SON functionality and behavior has been defined and specified in generally accepted mobile industry recommendations produced by organizations such as 3GPP and the NGMN (Next Generation Mobile Networks).

In 3GPP, the processes within the SON area are classified into Self-configuration process and Self-optimization process. A self-configuration process includes a process where newly deployed nodes are configured by automatic installation procedures to get the necessary basic configuration for system operation.

This process works in a pre-operational state. Pre-operational state may be understood as the state from when the eNB is powered up and has backbone connectivity until the RF transmitter is switched on.

FIG. 2 illustrates ramifications of Self-Configuration/Self-Optimization functionality (from 3GPP TS 36.300 V17.1.0 FIGS. 22.1-1).

As illustrated in FIG. 2, functions handled in the pre-operational state, such as Basic Setup and Initial Radio Configuration, are covered by the Self Configuration process.

A self-optimization process may be defined as the process where UE and access node measurements and performance measurements are used to auto-tune the network.

This process works in an operational state. An operational state may be understood as the state where the RF interface is additionally switched on.

As described in FIG. 2, functions handled in the operational state, such as Optimization/Adaptation, are covered by the Self Optimization process.

In LTE, support for Self-Configuration and Self-Optimisation is specified, as described in 3GPP TS 36.300 V17.1.0 section 22.2, including features such as Dynamic configuration, Automatic Neighbour Relation (ANR), Mobility load balancing, Mobility Robustness Optimization (MRO), RACH optimization and support for energy saving.

In NR, support for Self-Configuration and Self-Optimisation is specified as well, starting with Self-Configuration features such as Dynamic configuration, Automatic Neighbour Relation (ANR) in Rel-15, as described in 3GPP TS 38.300 V17.1.0 section 15. In NR Rel-16, more SON features are being specified for, including Self-Optimisation features such as Mobility Robustness Optimization (MRO).

Successful Handover (HO) report (SHR) has been standardized as part of 3GPP Rel 17 TS e.g., see RRC spec 38.331 (V17.0.0). A main purpose of the successful HO report is to enable the network nodes to deduce sub-optimal performance of the underlaying procedures executed during the HO procedure.

The network node upon being interested in SHR, can configure the UE to report the SHR after successful execution of a HO, if at least one of the SHR triggering conditions/thresholds is met. The SHR triggering thresholds are defined as following: whether the T304 timer value was above a certain threshold at the time of successful HO execution (thresholdPercentageT304); whether the T310 timer value was above a certain threshold at the time of successful HO execution (thresholdPercentageT310); whether the T312 timer value was above a certain threshold at the time of successful HO execution (thresholdPercentageT312); whether the UE experienced RLF at source node while performing a DAPS HO (sourceDAPS-FailureReporting).

When storing the successful handover report, the UE may include various information to aid the network to optimize the handover, such as measurements of the neighbouring cells, the fulfilled condition that triggered the successful handover report (e.g. threshold on T310 exceeded, specific RLF issue in the source while doing DAPS HO), etc.

The SHR can be configured by a certain serving cell, and when triggering conditions for SHR logging are fulfilled, the UE stores this information until the NW requests it. In particular, the UE may indicate availability of SHR information in certain RRC message, such as RRCReconfigurationComplete, RRCReestablishmentComplete, RRCSetupComplete, RRCResumeComplete, and the network may request such information via the UEInformationRequest message, upon which the UE transmits the stored SHR in the UEInformationResponse message.

Multi-Radio Dual Connectivity (MR-DC) describes the scenario where a UE that is capable of connecting to multiple nodes utilizes the multiple resources to increase throughput as described in TS 37.340 V 17.1.0. The following is a generalization of the intra-E-UTRA Dual connectivity described in TS 36.300 V 17.1.0.

When a UE is in DC mode, one node acts as the Master node (MN) and the other node acts as a Secondary node (SN). The MN and SN are connected via a network interface and at least the MN is connected to the core network. Details on MR-DC can be found in TS 38.401. The primary cell in MN is known as primary cell (PCell) and the primary cell in SN is known as primary secondary cell (PSCell).

### SUMMARY

Some embodiments are directed to a method performed by a first network node to identify a network node that initiated a PSCell change that results in generation of a report from a UE. The method comprises signaling a request to a second network node comprising a request for a PSCell change comprising a PSCell addition or a SN addition and a first indication related to the PSCell change. The first indication indicates that the PSCell change is related one of the first network node initiating the PSCell change or the second network node initiating the PSCell change. The method further includes receiving a message from the second network node comprising the report; and performing, based on the first indication, one of: (i) if the PSCell change was initiated by the first network node, analyzing the report to improve the PSCell change, and (ii) if the PSCell change was initiated by the second network node, forwarding the report to at least one additional network node.

Some other embodiments are directed to a method performed by a second network node to identify a network node that initiated a PSCell change that results in generation of a report from a UE. The method comprises receiving a request from a first network node. The request comprises a request for a PSCell change comprising a PSCell addition or a SN addition and a first indication related to the PSCell change. The first indication indicates that the PSCell change is related one of the first network node initiating the PSCell change or the second network node initiating the PSCell change. The method further comprises sending a message to the first network node comprising the report and the first indication.

Some other embodiments are directed to a method performed by a first network node operating as a master node for a UE to identify whether a PSCell change that results in generation of a report from the UE was initiated by the master node or a secondary node. The method comprises signaling an identifier to the UE. The identifier comprises an index to retrieve a portion of context of the UE comprising that the PSCell change is associated with one of the master node initiating the PSCell change or the secondary node initiating the PSCell change. The method further comprises storing, at a release of the UE, (i) the portion of a context of the UE related to a PSCell change, and (ii) the identifier; and receiving a report from the UE or another network node. The report comprises the identifier. The method further comprises identifying, based on the identifier, whether the report was generated after the master node initiated PSCell change or the secondary node PSCell change; and performing, based on the identifier, one of: (i) if the PSCell change was initiated by the master node, analyzing the report to improve the PSCell change, and (ii) if the PSCell change was initiated by a secondary node, forwarding the report to at least one of a source master node and a target secondary node.

Some other embodiments are directed to a first network node configured to identify a network node that initiated a PSCell change that results in generation of a report from a UE. The first network node comprises processing circuitry; and memory coupled with the processing circuitry. The memory includes instructions that when executed by the processing circuitry causes the first network node to perform operations. The operations comprise to signal a request to a second network node comprising a request for a PSCell change comprising a PSCell addition or a SN addition and a first indication related to the PSCell change. The first indication indicates that the PSCell change is related one of the first network node initiating the PSCell change or the second network node initiating the PSCell change. The operations further comprise to receive a message from the second network node comprising the report; and to perform, based on the first indication, one of: (i) if the PSCell change was initiated by the first network node, analyzing the report to improve the PSCell change, and (ii) if the PSCell change was initiated by the second network node, forwarding the report to at least one additional network node.

Some other embodiments are directed to a first network node configured to identify a network node that initiated a PSCell change that results in generation of a report from a UE. The first network node is adapted to perform operations. The operations comprise to signal a request to a second network node comprising a request for a PSCell change comprising a PSCell addition or a SN addition and a first indication related to the PSCell change. The first indication indicates that the PSCell change is related one of the first network node initiating the PSCell change or the second network node initiating the PSCell change. The operations further comprise to receive a message from the second network node comprising the report; and to perform, based on the first indication, one of: (i) if the PSCell change was initiated by the first network node, analyzing the report to improve the PSCell change, and (ii) if the PSCell change was initiated by the second network node, forwarding the report to at least one additional network node.

Some other embodiments are directed to a computer program comprising program code to be executed by processing circuitry of a first network node configured to identify a network node that initiated a PSCell change that results in generation of a report from a UE. Execution of the program code causes the first network node to perform operations. The operations comprise to signal a request to a second network node comprising a request for a PSCell change comprising a PSCell addition or a SN addition and a first indication related to the PSCell change. The first indication indicates that the PSCell change is related one of the first network node initiating the PSCell change or the second network node initiating the PSCell change. The operations further comprise to receive a message from the second network node comprising the report; and to perform, based on the first indication, one of: (i) if the PSCell change was initiated by the first network node, analyzing the report to improve the PSCell change, and (ii) if the PSCell change was initiated by the second network node, forwarding the report to at least one additional network node.

Some other embodiments are directed to a computer program product comprising a non-transitory storage medium including program code to be executed by processing circuitry of a first network node configured to identify a network node that initiated a PSCell change that results in generation of a report from a UE. Execution of the program code causes the first network node to perform operations. The operations comprise to signal a request to a second network node comprising a request for a PSCell change comprising a PSCell addition or a SN addition and a first indication related to the PSCell change. The first indication indicates that the PSCell change is related one of the first network node initiating the PSCell change or the second network node initiating the PSCell change. The operations further comprise to receive a message from the second network node comprising the report; and to perform, based on the first indication, one of: (i) if the PSCell change was initiated by the first network node, analyzing the report to improve the PSCell change, and (ii) if the PSCell change was initiated by the second network node, forwarding the report to at least one additional network node.

Some other embodiments are directed to a second network node configured to identify a network node that initiated a PSCell change that results in generation of a report from a UE. The second network node comprises processing circuitry; and memory coupled with the processing circuitry. The memory includes instructions that when executed by the processing circuitry causes the second network node to perform operations. The operations comprise to receive a request from a first network node. The request comprises a request for a PSCell change comprising a PSCell addition or a SN addition and a first indication related to the PSCell change. The first indication indicates that the PSCell change is related one of the first network node initiating the PSCell change or the second network node initiating the PSCell change. The operations further comprise to send a message to the first network node comprising the report and the first indication.

Some other embodiments are directed to a second network node configured to identify a network node that initiated a PSCell change that results in generation of a report from a UE. The second network node is adapted to perform operations. The operations comprise to receive a request from a first network node. The request comprises a request for a PSCell change comprising a PSCell addition or a SN addition and a first indication related to the PSCell change. The first indication indicates that the PSCell change is related one of the first network node initiating the PSCell change or the second network node initiating the PSCell change. The operations further comprise to send a message to the first network node comprising the report and the first indication.

Some other embodiments are directed to a computer program comprising program code to be executed by processing circuitry of a second network node configured to identify a network node that initiated a PSCell change that results in generation of a report from a UE. Execution of the program code causes the first network node to perform operations. The operations comprise to receive a request from a first network node. The request comprises a request for a PSCell change comprising a PSCell addition or a SN addition and a first indication related to the PSCell change. The first indication indicates that the PSCell change is related one of the first network node initiating the PSCell change or the second network node initiating the PSCell change. The operations further comprise to send a message to the first network node comprising the report and the first indication.

Some other embodiments are directed to a computer program product comprising a non-transitory storage medium including program code to be executed by processing circuitry of a second network node configured to identify a network node that initiated a PSCell change that results in generation of a report from a UE. Execution of the program code causes the second network node to perform operations. The operations comprise to receive a request from a first network node. The request comprises a request for a PSCell change comprising a PSCell addition or a SN addition and a first indication related to the PSCell change. The first indication indicates that the PSCell change is related one of the first network node initiating the PSCell change or the second network node initiating the PSCell change. The operations further comprise and to send a message to the first network node comprising the report and the first indication.

Some other embodiments are directed to a first network node operating as a master node for a UE to identify whether a PSCell change that results in generation of a report from the UE was initiated by the master node or a secondary node. The first network node comprises processing circuitry; and memory coupled with the processing circuitry. The memory includes instructions that when executed by the processing circuitry causes the first network node to perform operations. The operations comprise to signal an identifier to the UE. The identifier comprises an index to retrieve a portion of context of the UE comprising that the PSCell change is associated with one of the master node initiating the PSCell change or the secondary node initiating the PSCell change. The operations further comprise to store, at a release of the UE, (i) the portion of a context of the UE related to a PSCell change, and (ii) the identifier. The operations further comprise to receive a report from the UE or another network node. The report comprises the identifier. The operations further comprise to identify, based on the identifier, whether the report was generated after the master node initiated PSCell change or the secondary node PSCell change; and to perform, based on the identifier, one of: (i) if the PSCell change was initiated by the master node, analyzing the report to improve the PSCell change, and (ii) if the PSCell change was initiated by a secondary node, forwarding the report to at least one of a source master node and a target secondary node.

Some other embodiments are directed to a first network node operating as a master node for a UE to identify whether a PSCell change that results in generation of a report from the UE was initiated by the master node or a secondary node. The first network node is adapted to perform operations. The operations comprise to signal an identifier to the UE. The identifier comprises an index to retrieve a portion of context of the UE comprising that the PSCell change is associated with one of the master node initiating the PSCell change or the secondary node initiating the PSCell change. The operations further comprise to store, at a release of the UE, (i) the portion of a context of the UE related to a PSCell change, and (ii) the identifier; and to receive a report from the UE or another network node. The report comprises the identifier. The operations further comprise to identify, based on the identifier, whether the report was generated after the master node initiated PSCell change or the secondary node PSCell change; and to perform, based on the identifier, one of: (i) if the PSCell change was initiated by the master node, analyzing the report to improve the PSCell change, and (ii) if the PSCell change was initiated by a secondary node, forwarding the report to at least one of a source master node and a target secondary node.

Some other embodiments are directed to a computer program comprising program code to be executed by processing circuitry of a first network node operating as a master node for a UE to identify whether a PSCell change that results in generation of a report from the UE was initiated by the master node or a secondary node. Execution of the program code causes the first network node to perform operations. The operations comprise to signal an identifier to the UE. The identifier comprises an index to retrieve a portion of context of the UE comprising that the PSCell change is associated with one of the master node initiating the PSCell change or the secondary node initiating the PSCell change. The operations further comprise to store, at a release of the UE, (i) the portion of a context of the UE related to a PSCell change, and (ii) the identifier; and to receive a report from the UE or another network node. The report comprises the identifier. The operations further comprise to identify, based on the identifier, whether the report was generated after the master node initiated PSCell change or the secondary node PSCell change; and to perform, based on the identifier, one of: (i) if the PSCell change was initiated by the master node, analyzing the report to improve the PSCell change, and (ii) if the PSCell change was initiated by a secondary node, forwarding the report to at least one of a source master node and a target secondary node.

Some other embodiments are directed to a computer program product comprising a non-transitory storage medium including program code to be executed by processing circuitry of a first network node operating as a master node for a UE to identify whether a PSCell change that results in generation of a report from the UE was initiated by the master node or a secondary node. Execution of the program code causes the first network node to perform operations. The operations comprise to signal an identifier to the UE. The identifier comprises an index to retrieve a portion of context of the UE comprising that the PSCell change is associated with one of the master node initiating the PSCell change or the secondary node initiating the PSCell change. The operations further comprise to store, at a release of the UE, (i) the portion of a context of the UE related to a PSCell change, and (ii) the identifier; and to receive a report from the UE or another network node, the report comprising the identifier. The operations further comprise to identify, based on the identifier, whether the report was generated after the master node initiated PSCell change or the secondary node PSCell change; and to perform, based on the identifier, one of: (i) if the PSCell change was initiated by the master node, analyzing the report to improve the PSCell change, and (ii) if the PSCell change was initiated by a secondary node, forwarding the report to at least one of a source master node and a target secondary node.

Other methods, network nodes, and related devices according to embodiments will be or become apparent to one with skill in the art upon review of the following drawings and detailed description. It is intended that all such additional methods, network nodes, and related devices be included within this description and protected by the accompanying claims.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram illustrating a wireless communication system in 3GPP;

FIG. 2 is a schematic diagram illustrating ramifications of Self-Configuration/Self-Optimization functionality;

FIG. 3 is a flowchart illustrating operations of a first network node in accordance with some embodiments;

FIG. 4 is a flowchart illustrating operations of a second network node in accordance with some embodiments;

FIG. 5 is a flowchart illustrating operations a first network node operating as a master node in accordance with some embodiments;

FIG. 6 is a block diagram of a communication system in accordance with some embodiments;

FIG. 7 is a block diagram of a user equipment in accordance with some embodiments;

FIG. 8 is a block diagram of a network node in accordance with some embodiments;

FIG. 9 is a block diagram of a host computer communicating with a user equipment in accordance with some embodiments;

FIG. 10 is a block diagram of a virtualization environment in accordance with some embodiments; and

FIG. 11 is a block diagram of a host computer communicating via a base station with a user equipment over a partially wireless connection in accordance with some embodiments in accordance with some embodiments.

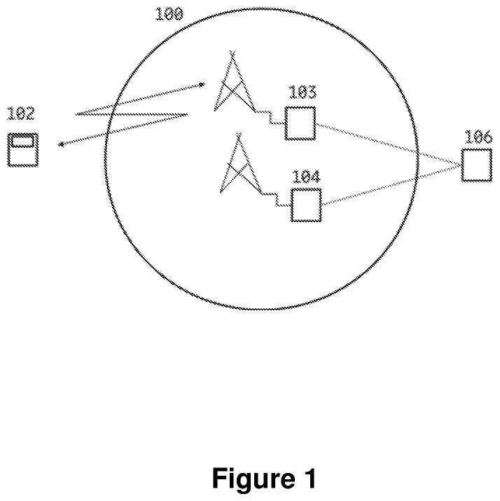

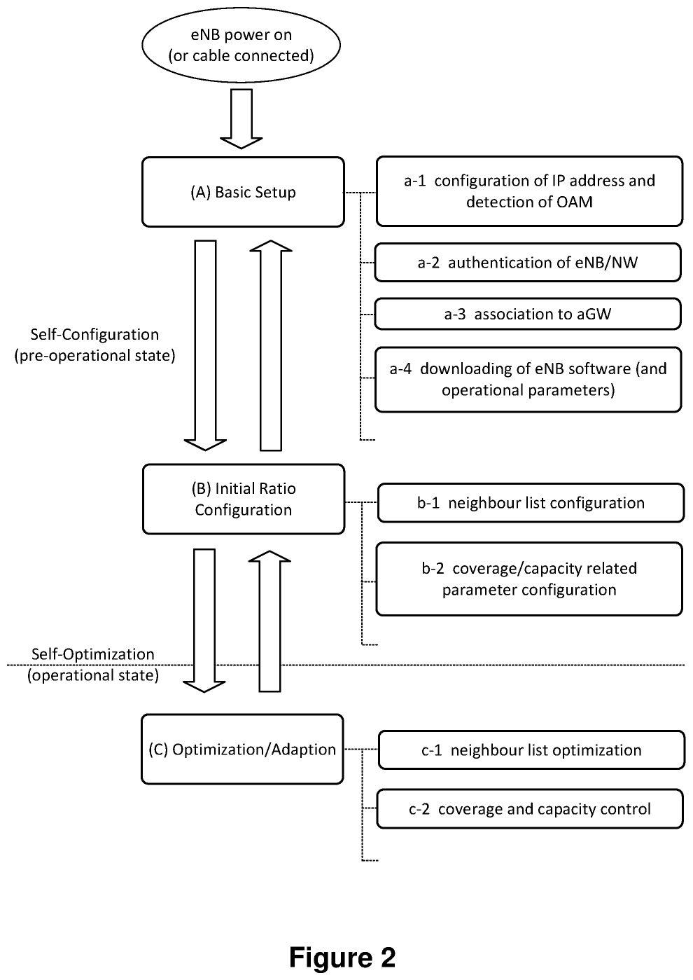

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The node receiving (e.g., from a network node or from the UE) the Successful PSCell Report (SPR) needs to understand if the PSCell Change was MN-initiated (i.e. decision to perform PSCell Change was taken by the MN), or SN-initiated (i.e. decision to perform PSCell Change was taken by the SN). This information is needed to identify which node needs to analyze the SPR (e.g., MN if MN-initiated or SN if SN-initiated) and if the SPR needs to be transferred to this node.

One approach may be to keep the UE Context after each PSCell Change, including the cell radio network temporary identifier (C-RNTI) identifying the UE. But this may be highly inefficient/costly and resource consuming as the network node will need to keep this UE Context for up to 48 hours (if the network is allowed to fetch the SPR within 48 hours). This also may forbid the network nodes to re-use the C-RNTI for a new UE, which may be a problem as the C-RNTI is a scarce resource. In addition, the network node configuring the UE to collect the SPR is not aware of whether the SPR triggering conditions were met and the SPR is actually logged by the UE or not. Some embodiments of the present disclosure may avoid such highly inefficient/costly and resource consumption, may allow re-using, and may render the awareness. Additionally, it may be desirable not to use the existing internal C-RNTI algorithm for C-RNTI selection for a UE to reserve and remember the UE context.

Ongoing rel-18 Work Item “New WID on further enhancement of data collection for SON (Self-Organising Networks)/MDT (Minimization of Drive Tests) in NR standalone and MR-DC (Multi-Radio Dual Connectivity)” includes the following objective: Support of SON/MDT enhancements for Successful PScell change report.

A Successful PScell (change) report, or SPR, may have the same properties as the above described SHR, but is related to PSCell Change/Addition events, which may mean that the UE will generate an SPR, if events configured by the network are triggered during a PSCell Change or PSCell Addition. The UE may advertise the presence of the SPR to the network, which may, in return, fetch it. Network signaling may then be used to send the SPR to the node which configured the event which triggered the creation of the SPR. This SPR may finally be used by the network node to optimize PSCell Change/Addition.

The term “PSCell change” is used herein to refer to a PSCell change and/or a PSCell addition. The term “report” is used herein to refer to a report from a UE in response to a successful PSCell report including, without limitation, a SPR.

Various embodiments of the present disclosure are directed to operations performed by a network node receiving the report (e.g., from another network node or from the UE directly) to identify whether the PSCell Change generating a report was MN-initiated or SN-initiated.

According to some embodiments:
A MN can signal an indicator to a target SN at a request (e.g., a SN Addition request), and attaching the indicator to the report. The indicator may indicate:
   that the PSCell change (e.g., SN Addition) is linked to a MN-initiated PSCell change, or
   that the PSCell change (e.g., SN Addition) is linked to a SN-initiated PSCell change;
   This indicator may, in return, be attached to the report fetched by the SN, when sending it to source SN or MN;
Signaling (MN or SN or both) Mobility Information to the target SN at PSCell change (e.g., SN Addition), and attaching it to the report may include:
   Mobility Information including information related to the PSCell change, including a PSCell change type (i.e. MN-initiated or SN-initiated);
   Mobility Information may, in return, be attached to the report fetched by the SN, when sending it to source SN or MN;
The MN signaling Mobility Information to a re-establishment node at a retrieval of UE context (e.g., a Retrieve UE Context Response), and attaching it to the report may include:
   Mobility Information including information related to the PSCell change, including a PSCell change type (i.e. MN-initiated or SN-initiated);
   Mobility Information may, in return, be attached to the report fetched by the re-establishment node, when sending it to source SN or MN;
Using the identifier may include using the identifier as an index to retrieve part of a UE Context needed to analyze the report. The identifier may:
   Be based on an inactive radio network temporary identifier, I-RNTI, or part of I-RNTI or be a completely new identifier;
   Be sent to the UE at dual connectivity (DC) initiation;
   Be added to the report by the UE;
   Be used by the network node as an index to the UE context, the UE context including at least a PSCell change type (i.e. MN-initiated or SN-initiated).

Various embodiments of the present disclosure are directed to operations for new inter-node signaling. The signaling may include:
an indicator in a message, e.g., a SN Addition Request message, indicating whether the PSCell change (e.g., SN Addition) is related to an MN-initiated PSCell Change or an SN-initiated PSCell Change;
   This indicator can be added to the Mobility Information instead, and the Mobility Information can be added to the message (e.g., to a SN Addition Request message);
an indicator in a message conveying the SPR from the target to the source, indicating whether the PSCell change (e.g., SN Addition) is related to an MN-initiated PSCell Change or an SN-initiated PSCell Change;
   This indicator can be added to the Mobility Information instead, and the Mobility Information can be added to the message conveying the SPR;
In accordance with various embodiments of the present, operations by a network node include to signal an identifier to the UE, which can be added by the UE to the SPR. This identifier can be used by the network node which generated the identifier to identify stored UE Context related to the received SPR.

Potential advantages of one or more embodiments of the present disclosure can include that the network node receiving the report (for initial analysis and/or optimization/improvement) will know if the PSCell change related to the received report was MN-initiated or SN-initiated, and without keeping the full UE Context and the C-RNTI given to the UE. Knowing the initiator of the PSCell change (i.e., either MN initiated, or SN initiated PSCell change) may assist the network to send/forward the report to the right network node (e.g., which may be likely to be the node who initiated the PSCell change) for analysis of the report and optimization of the PSCell change configuration parameters.

The term network node herein may be interchangeable and replaced with the term radio access node (RAN node). Furthermore, the terms MN and SN can be different from a UE perspective. For example, the same network node can act as MN and SN simultaneously for different UEs.

Operations of a network node include indicating a PSCell change type (in other words, whether a PSCell change related to the received report was MN-initiated or SN-initiated) to a target SN.

Some embodiments are directed to a method performed by a first network node.

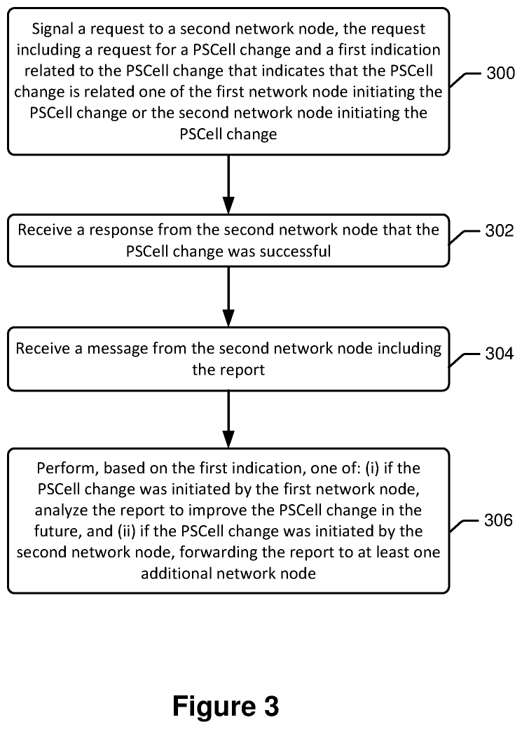

As illustrated in FIG. 3, a method performed by a first network node to identify a network node that initiated a PSCell change that results in generation of a report from a UE is provided. The method includes signaling (300) a request to a second network node including a request for a PSCell change and a first indication related to the PSCell change. The first indication indicates that the PSCell change is related one of the first network node initiating the PSCell change or the second network node initiating the PSCell change. The method further includes receiving (302) a response from the second network node that the PSCell change was successful. The method further includes receiving (304) a message from the second network node including the report. The method further includes performing (306), based on the first indication, one of: (i) if the PSCell change was initiated by the first network node, analyzing the report to improve the PSCell change, and (ii) if the PSCell change was initiated by the second network node, forwarding the report to at least one additional network node.

In some embodiments, the first network node is operating as a Master Node (MN).

The operations include sending a first indication (e.g., as part of a SN Addition request or a Retrieve UE Context Response) to a second network node for a PSCell change. In an example embodiment, the first indication is included in one of a message including a request for the PSCell change to a secondary node or a response to retrieve context from the UE.

The first indication may indicate that the PSCell change (e.g., SN Addition) is related to an MN-initiated PSCell Change, or an SN-initiated PSCell change, by adding the indicator to a message (e.g., the SN Addition message). In an example embodiment, the first indication indicates that the PSCell change is related to one of the first network node initiating the PSCell change or the second network node initiating the PSCell change.

In another or alternative embodiment, the indication is added only in case of a SN-initiated PSCell change. According to some embodiments, the first network node is operating as a master node, the second network node is operating as a secondary node, and the first indication is included when the second network node initiated the PSCell change.

In another or alternative embodiment, the MN adds MN Mobility Information or SN Mobility Information or both to the message (e.g., a SN Addition message or a Retrieve UE Context Response), the Mobility Information including necessary information (e.g. a single bit with value “0” for MN-initiated and value “1” for SN-initiated) to identify whether PSCell Change was MN-initiated or SN-initiated. In an example embodiment, the first network node is operating as a master node, the second network node is operating as a secondary node, and the first indication is included in at least one of (i) a master node mobility information, (ii) a secondary node mobility information, or (iii) a secondary node addition message and a response to retrieve context from the UE, and wherein the mobility information comprises the first indication that identifies whether the PSCell change was master node initiated or secondary node initiated.

In some embodiments, the first indication from the first network node (e.g., the source MN) to the second network node (e.g., the target SN) is sent responsive to receiving an indication from another network node (e.g., the source SN) including the initiator of the SN change and/or the Mobility Information of the initiator of the SN change (e.g., the source SN). In an example embodiment, the first network node is operating as a source master node, the second network node is operating as a target secondary node, the signaling (300) the first indication is signaled responsive to receiving a second indication from a third network node comprising a source secondary node, and wherein the second indication includes identification of the initiator of secondary node change and/or a mobility information of the secondary node change.

In some embodiments, in response to the received indication from the other RAN node (e.g., the source SN), the first network node (e.g., the source MN) sends the first indication (e.g., SN addition request) to the second network node (e.g., the target SN) and the first indication includes the initiator of the SN change and/or the Mobility Information associated to the initiator of the SN change. In an example embodiment, responsive to the received second indication, the first network node signals the first indication to the second network node and the first indication includes the identification of the initiator of secondary node change and/or the mobility information of the secondary node change.

In other embodiments, the first network node (e.g., the source MN) sends the first indication to another RAN node (e.g., the target MN), wherein the first indication includes the initiator of the SN change and/or the Mobility Information of the initiator of the SN change. In an example embodiment, the first network node is operating as a source master node, the second network node is operating as a target master node, and the first indication includes identification of the initiator of secondary node change and/or a mobility information of the initiator of the secondary node change.

In some embodiments, sending the indications from the first network node to the second network node or the other network node is subject to the fact that the UE is configured with the SPR configuration by the SN change/addition initiator node. In an example embodiment, the signaling (operation 300 of the method of FIG. 3) the first indication is subject to the UE being configured with a configuration of the report by the network node that initiated the PSCell change.

The operations include receiving a response from the second network node that the PSCell change (e.g., a SN Addition request) is successful.

The operations include receiving a report in a message from the second network node or a third network node. The message containing the report may also contain the information that the PSCell Change was MN-initiated or SN-initiated, this information comprising the indicator.

In another or alternative embodiment, the indicator is added only in case the report is related to an SN-initiated PSCell change. In an example embodiment, the first network node is operating as a master node, the second network node is operating as a secondary network node, the report comprises the first indicator, and first indicator is included when the report is related to the secondary network node initiating the PSCell change.

In another or alternative embodiment, the message containing the report may also contain MN Mobility Information or SN Mobility Information or both, the Mobility Information including necessary information to identify if PSCell Change was MN-initiated or SN-initiated. In an example embodiment, the message from the second network node comprising the report further comprises at least one of (i) a master node mobility information, (ii) a secondary node mobility information, and wherein the mobility information comprises information to identify whether the PSCell change was master node initiated or secondary node initiated.

In yet another or alternative embodiment, the information that the report is linked to an MN-initiated PSCell Change or an SN-initiated PSCell Change is contained in the report itself. In an example embodiment, the report comprises information that the report is linked to a master node initiated PSCell change or an SN initiated PSCell change.

The operations include if the PSCell Change was MN-initiated, the MN analyzes the report contents in order to optimize a future PSCell Change.

The operations include if the PSCell Change was SN-initiated, the MN forwards the SPR to source MN, target SN or both.

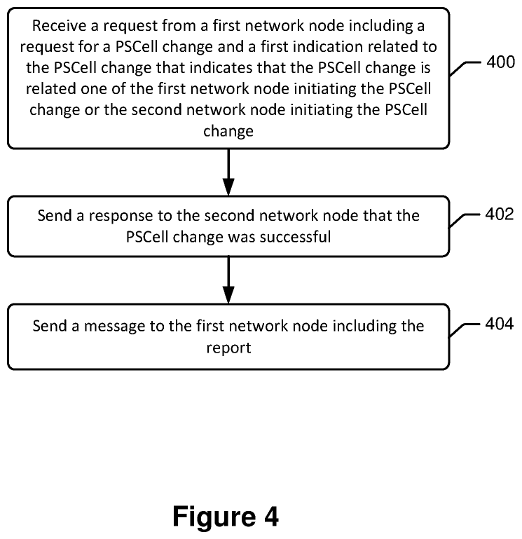

Some other embodiments are directed to a method performed by a second network node. As illustrated in FIG. 4, a method performed by a second network node to identify a network node that initiated a PSCell change that results in generation of a report from a UE is provided. The method includes receiving (400) a request from a first network node. The request includes a request for a PSCell change and a first indication related to the PSCell change. The first indication indicates that the PSCell change is related one of the first network node initiating the PSCell change or the second network node initiating the PSCell change. The method further includes sending (402) a response to the second network node that the PSCell change was successful. The method further includes sending (404) a message to the first network node including the report.

In some embodiments, the second network node is operating as a Secondary Node (SN).

In some embodiments, the second network node is operating as the re-establishment node, i.e., a node where the UE performs RRC Re-establishment after a Radio Link Failure (RLF).

In an example embodiment, the second network node is operating as one of a secondary node and a node that performs re-establishment after a radio link failure, RLF.

The operations include receiving a PSCell change (e.g., an SN Addition request) from a first network node operating as MN for a PSCell change. In an example embodiment, the first network node is operating as a master node for the PSCell change.

The operations (e.g., operation 400 of the method of FIG. 4) include receiving the information that the PSCell change (e.g., SN Addition) is related to an MN-initiated PSCell Change, or an SN-initiated PSCell change, by receiving the indicator in the message (e.g., the SN Addition message).

In another or alternative embodiment, the indicator is received only in case of SN-initiated PSCell change. In an example embodiment, first network node is operating as a master node, the second network node is operating as a secondary node, and the first indicator is received in a case of a secondary node initiated PSCell change.

In another or alternative embodiment, the SN will receive MN Mobility Information or SN Mobility Information or both in the SN Addition message, the Mobility Information containing necessary information to identify if PSCell Change was MN-initiated or SN-initiated. In an example embodiment, the first network node is operating as a master node, the second network node is operating as a secondary node, and the receiving (404) a request further includes at least one of (i) a master node mobility information, and (ii) a secondary node mobility information, and wherein the mobility information comprises the first indication that identifies whether the PSCell change was master node initiated or secondary node initiated.

The operations include sending (e.g., operation 402 of the method of FIG. 4) a response to the first network node that the PSCell change (e.g., SN Addition request) is successful.

In some embodiments, the operations include receiving an indication from the UE that a report is available in the UE memory.

In some embodiments, the operations include fetching the report from the UE.

The operations include sending (e.g., operation 404 of the method of FIG. 4) the report to the first network node. The message including the report may also contain the information that the PSCell Change was MN-initiated or SN-initiated, this information being the indicator.

In another or alternative embodiment, the indicator is added only in case the report is related to an SN-initiated PSCell change. In an example embodiment, the first network node is operating as a master node, the second network node is operating as a secondary network node, the report comprises the first indicator, and first indicator is included when the report is related to the secondary network node initiating the PSCell change.

In another or alternative embodiment, the message including the report may also contain MN Mobility Information or SN Mobility Information or both, which were received from the first network node in the PSCell change (e.g., SN Addition), the Mobility Information containing necessary information to identify if PSCell Change was MN-initiated or SN-initiated. In an example embodiment, the message to the first network node comprising the report further includes at least one of (i) a master node mobility information, (ii) a secondary node mobility information, and wherein the mobility information comprises information to identify whether the PSCell change was master node initiated or secondary node initiated.

In yet another or alternative embodiment, the information that the report is linked to an MN-initiated PSCell Change or an SN-initiated PSCell Change is contained in the report itself. In an example embodiment, the report includes information that the report is linked to a master node initiated PSCell change or a secondary node initiated PSCell change.

Example embodiments of an implementation in TS 38.423 V 17.1.0 are described below:

### S-Node Addition Request

This message is sent by the M-NG-RAN node to the S-NG-RAN node to request the preparation of resources for dual connectivity operation for a specific UE.

The direction is from M-NG-RAN node to S-NG-RAN node.

TABLE 1

| | | | IE type | |
|---|---|---|---|---|
| | | | and | |
| IE/Group Name | Presence | Range | reference | Semantics description |
| Message Type | M | | 9.2.3.1 | |
| M-NG-RAN node UE XnAP | M | | NG-RAN | Allocated at the M-NG- |
| ID | | | node UE | RAN node |
| | | | XnAP ID | |
| | | | 9.2.3.16 | |
| UE Security Capabilities | M | | 9.2.3.49 | |
| S-NG-RAN node Security | M | | 9.2.3.51 | |
| Key | | | | |
| S-NG-RAN node UE | M | | UE | The UE Aggregate |
| Aggregate Maximum Bit | | | Aggregate | Maximum Bit Rate is |
| Rate | | | Maximum | split into M-NG-RAN |
| | | | Bit | node UE Aggregate |
| | | | Rate | Maximum Bit Rate and |
| | | | 9.2.3.17 | S-NG-RAN node UE |
| | | | | Aggregate Maximum Bit |
| | | | | Rate which are enforced |
| | | | | by M-NG-RAN node and |
| | | | | S-NG-RAN node |
| | | | | respectively. |
| Selected PLMN | O | | PLMN | The selected PLMN of |
| | | | Identity | the SCG in the S-NG-RAN |
| | | | 9.2.2.4 | node. |
| Mobility Restriction List | O | | 9.2.3.53 | |
| Index to RAT/Frequency | O | | 9.2.3.23 | |
| Selection Priority | | | | |
| PDU Session Resources To | | 1 | | |
| Be Added List | | | | |
| >PDU Session Resources | | 1 . . . | | NOTE: If neither the PDU |
| To Be Added Item | | <maxnoof | | Session Resource Setup |
| | | PDUSessions> | | Info - SN terminated IE |
| | | | | nor the PDU Session |
| | | | | Resource Setup Info - |
| | | | | MN terminated IE is |
| | | | | present in a PDU Session |
| | | | | Resources To Be Added |
| | | | | Item IE, abnormal |
| | | | | conditions as specified in |
| | | | | clause 8.3.1.4 apply. |
| >>PDU Session ID | M | | 9.2.3.18 | |
| >>S-NSSAI | M | | 9.2.3.21 | |
| >>S-NG-RAN node PDU | O | | PDU | |
| Session Aggregate | | | Session | |
| Maximum Bit Rate | | | Aggregate | |
| | | | Maximum | |
| | | | Bit | |
| | | | Rate | |
| | | | 9.2.3.69 | |
| >>PDU Session Resource | O | | 9.2.1.5 | |
| Setup Info - SN | | | | |
| terminated | | | | |
| >>PDU Session Resource | O | | 9.2.1.7 | |
| Setup Info - MN | | | | |
| terminated | | | | |
| M-NG-RAN node to S-NG- | M | | OCTET | Includes the CG- |
| RAN node Container | | | STRING | ConfigInfo message as |
| | | | | defined in subclause |
| | | | | 11.2.2 of TS 38.331 [10] |
| S-NG-RAN node UE XnAP ID | O | | NG-RAN | Allocated at the S-NG- |
| | | | node UE | RAN node |
| | | | XnAP ID | |
| | | | 9.2.3.16 | |
| Expected UE Behaviour | O | | 9.2.3.81 | |
| Requested Split SRBs | O | | ENUMERATED | Indicates that resources |
| | | | (srb1, | for Split SRBs are |
| | | | srb2, | requested. |
| | | | srb1&2, . . . ) | |
| PCell ID | O | | Global | |
| | | | NG-RAN | |
| | | | Cell | |
| | | | Identity | |
| | | | 9.2.2.27 | |
| Desired Activity | O | | 9.2.3.77 | |
| Notification Level | | | | |
| Available DRB IDs | C- | | DRB List | Indicates the list of DRB |
| | ifSNterminated | | 9.2.1.29 | IDs that the S-NG-RAN |
| | | | | node may use for SN- |
| | | | | terminated bearers. |
| S-NG-RAN node Maximum | O | | Bit Rate | The S-NG-RAN node |
| Integrity Protected Data | | | 9.2.3.4 | Maximum Integrity |
| Rate Uplink | | | | Protected Data Rate |
| | | | | Uplink is a portion of the |
| | | | | UE's Maximum Integrity |
| | | | | Protected Data Rate in |
| | | | | the Uplink, which is |
| | | | | enforced by the S-NG- |
| | | | | RAN node for the UE's |
| | | | | SN terminated PDU |
| | | | | sessions. If the S-NG- |
| | | | | RAN node Maximum |
| | | | | Integrity Protected Data |
| | | | | Rate Downlink IE is not |
| | | | | present, this IE applies to |
| | | | | both UL and DL. |
| S-NG-RAN node Maximum | O | | Bit Rate | The S-NG-RAN node |
| Integrity Protected Data | | | 9.2.3.4 | Maximum Integrity |
| Rate Downlink | | | | Protected Data Rate |
| | | | | Downlink is a portion of |
| | | | | the UE's Maximum |
| | | | | Integrity Protected Data |
| | | | | Rate in the Downlink, |
| | | | | which is enforced by the |
| | | | | S-NG-RAN node for the |
| | | | | UE's SN terminated PDU |
| | | | | sessions. |
| Location Information at S- | O | | ENUMERATED | Indicates that the user's |
| NODE reporting | | | (pscell, . . . ) | Location Information at |
| | | | | S-NODE is to be |
| | | | | provided. |
| MR-DC Resource | O | | 9.2.2.33 | Information used to |
| Coordination Information | | | | coordinate resource |
| | | | | utilisation between M- |
| | | | | NG-RAN node and S-NG- |
| | | | | RAN node. |
| Masked IMEISV | O | | 9.2.3.32 | |
| NE-DC TDM Pattern | O | | 9.2.2.38 | |
| SN Addition Trigger | O | | ENUMERATED | This IE indicates the |
| Indication | | | (SN | trigger for S-NG-RAN |
| | | | change, | node Addition |
| | | | inter-MN | Preparation procedure |
| | | | HO, intra- | |
| | | | MN | |
| | | | HO, . . . ) | |
| Trace Activation | O | | 9.2.3.55 | |
| Requested Fast MCG | O | | ENUMERATED | Indicates that the |
| recovery via SRB3 | | | (true, . . . ) | resources for fast MCG |
| | | | | recovery via SRB3 are |
| | | | | requested. |
| UE Radio Capability ID | O | | 9.2.3.138 | |
| Source NG-RAN Node ID | O | | Global | The NG-RAN Node ID of |
| | | | NG-RAN | the source NG-RAN node |
| | | | Node ID | or the source SN. |
| | | | 9.2.2.3 | |
| Management Based MDT | O | | MDT | |
| PLMN List | | | PLMN List | |
| | | | 9.2.3.133 | |
| UE History Information | O | | 9.2.3.64 | |
| UE History Information | O | | 9.2.3.110 | |
| from the UE | | | | |
| PSCell Change History | O | | ENUMERATED | |
| | | | (reporting | |
| | | | full | |
| | | | history, . . . ) | |
| IAB Node Indication | O | | ENUMERATED | |
| | | | (true, . . . ) | |
| No PDU Session Indication | O | | ENUMERATED | Applicable to IAB-MT |
| | | | (true, . . . ) | only. |
| CHO Information SN | O | | | |
| Addition | | | | |
| >Source M-NG-RAN node | M | | Global | |
| ID | | | NG-RAN | |
| | | | Node ID | |
| | | | 9.2.2.3 | |
| >Source M-NG-RAN node | M | | NG-RAN | Allocated at the source |
| UE XnAP ID | | | node UE | M-NG-RAN node |
| | | | XnAP ID | |
| | | | 9.2.3.16 | |
| >Estimated Arrival | O | | INTEGER | |
| Probability | | | (1 . . . 100) | |
| SCG Activation Request | O | | 9.2.3.154 | |
| Conditional PSCell Addition | O | | | |
| Information Request | | | | |
| >Maximum Number of | M | | INTEGER | Indicates the maximum |
| PSCells To Prepare | | | (1 . . . 8, . . . ) | number of PSCells that |
| | | | | the target SN may |
| | | | | prepare. |
| >Estimated Arrival | O | | INTEGER | Indicates the arrival |
| Probability | | | (1 . . . 100) | probability for the UE |
| | | | | towards the candidate |
| | | | | target SN. |
| S-NG-RAN node UE Slice | O | | UE Slice | This IE indicates the S- |
| Maximum Bit Rate | | | Maximum | NG-RAN node portion of |
| | | | Bit | the UE Slice Aggregate |
| | | | Rate List | Maximum Bit Rate as |
| | | | 9.2.3.167 | specified in TS 23.501 [7] |
| PSCell Change Type | O | | ENUMERATED | Indicate if the SN |
| | | | (MN- | Addition is triggered by |
| | | | initiated, | an MN-initiated PSCell |
| | | | SN- | Change or an SN- |
| | | | initiated, | initiated PSCell Change |
| | | | . . . ) | |

### Access and Mobility Indication

This message is sent by NG-RAN node₁ to transfer access and mobility related information to NG-RAN node₂.

The direction is from NG-RAN node₁ to NG-RAN node₂.

TABLE 2

| | | | IE type | |
|---|---|---|---|---|
| | | | and | |
| IE/Group Name | Presence | Range | reference | Semantics description |
| Message Type | M | | 9.2.3.1 | |
| RACH Report List | | 0 . . . 1 | | |
| >RACH Report List Item | | 1 . . . | | |
| | | <maxnoofRACHReportS> | | |
| >>RACH Report Container | O | | OCTET | RA-ReportList-r16 IE as |
| | | | STRING | defined in subclause 6.2.2 |
| | | | | in TS 38.331 [10]. |
| >>UE Assistant Identifier | 0 | | NG-RAN | |
| | | | node UE | |
| | | | XnAP ID | |
| | | | 9.2.3.16 | |
| Successful HO Report List | | 0 . . . 1 | | |
| >Successful HO Report List | | 1 . . . | | |
| Item | | <maxnoofSuccessfulHOReports> | | |
| >>Successful HO Report | O | | OCTET | |
| Container | | | STRING | |
| Successful PSCell Report List | | 0 . . . 1 | | |
| >Successful PSCell Report | | 1 . . . | | |
| List Item | | <maxnoofSuccessfulPSCellReports> | | |
| >>Successful PSCell Report | M | | OCTET | |
| Container | | | STRING | |
| >>PSCell Change Type | O | | ENUMERATED | Indicate if the SPR is |
| | | | (MN- | related to an MN-initiated |
| | | | initiated, | PSCell Change or an SN- |
| | | | SN- | initiated PSCell Change |
| | | | initiated, | |
| | | | . . . ) | |

Operations performed by a first network node include an identifier as an index to stored UE context.

Some other embodiments are directed to operations by a first network node operating as a master node.

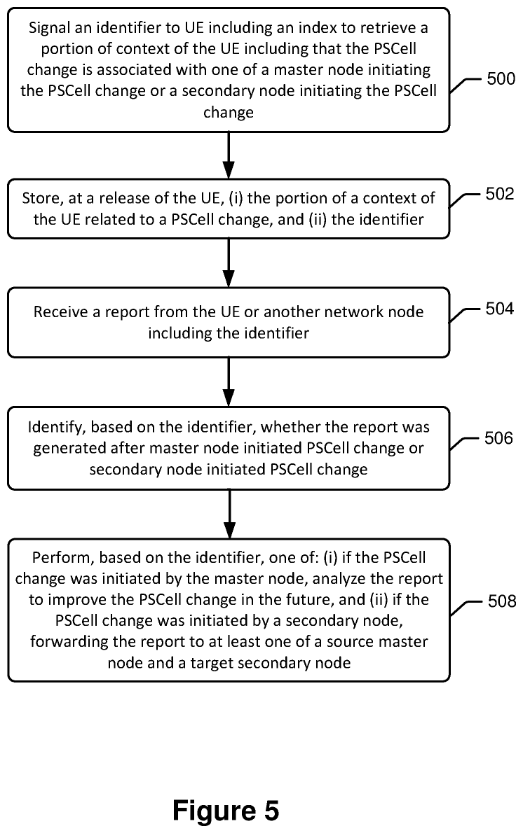

As illustrated in FIG. 5, a method is provided that is performed by a first network node operating as a master node for a UE to identify whether a PSCell change that results in generation of a report from the UE was initiated by the master node or a secondary node. The method includes signaling (500) an identifier to the UE. The identifier includes an index to retrieve a portion of context of the UE including that the PSCell change is associated with one of the master node initiating the PSCell change or the secondary node initiating the PSCell change. The method further includes storing (502), at a release of the UE, (i) the portion of a context of the UE related to a PSCell change, and (ii) the identifier. The method further includes receiving (504) a report from the UE or another network node. The report includes the identifier. The method further includes identifying (506), based on the identifier, whether the report was generated after the master node initiated PSCell change or the secondary node PSCell change. The method further includes performing (508), based on the identifier, one of: (i) if the PSCell change was initiated by the master node, analyzing the report to improve the PSCell change, and (ii) if the PSCell change was initiated by a secondary node, forwarding the report to at least one of a source master node and a target secondary node.

The operations include sending an identifier (e.g., a temporary identifier). The identifier may be: sent to the UE at Dual Connectivity setup; the identifier may be the I-RNTI; and/or the identifier may be a part of the I-RNTI. In an example embodiment, the signaling (500 of the method of FIG. 5) the identifier includes at least one of: (i) signaled at dual connectivity setup, (ii) signaled as an inactive-radio network temporary identifier, I-RNTI, and (iii) signaled as a portion of the I-RNTI.

In some embodiments, the identifier is sent to the UE along with report configuration, e.g., when a network node configures the UE to collect a report under certain triggering conditions, the network node sends the identifier, e.g., I-RNTI to the UE and the UE stores the received identifier, e.g., I-RNTI in addition to the report configuration at the UE memory. In an example embodiment, the signaling (500 of the method of FIG. 5) further includes a configuration for the UE to collect the report.

The operations include, at UE release, storing (e.g., operation 502 of the method of FIG. 5) part of the UE Context related to report (e.g. PSCell Change Type (MN or SN)) and/or the mobility control parameters and PSCell change triggering conditions together with the identifier.

The operations include receiving (e.g., operation 504 of the method of FIG. 5) a report from the UE or a second or a third network node, the report containing the identifier.

In some embodiments, upon triggering the report the UE compiles and logs the report and includes the received identifier (e.g., I-RNTI) in the report and later sends the report to the network.

The operations include fetching the UE Context (or part of the UE Context related to the report) from memory, based on the received identifier, and identify whether the report was generated after an MN-initiated or SN-initiated PSCell Change.

In an example embodiment, the signaling (500 of the method of FIG. 5) further includes a configuration for the UE to collect the report.

The operation include, if PSCell Change was MN-initiated, analyze the report contents in order to optimize future PSCell Change.

The operations include, if PSCell Change was SN-initiated, forward the report to source MN, target SN or both.

Additional embodiments of the present disclosure are directed to operations that are now further described.

Operations of a first network node can be performed by the RAN node 8300 of FIG. 8. Operations of the first network node (implemented using the structure of FIG. 8) have been discussed with reference to the flow chart of FIG. 3 according to some embodiments of the present disclosure. For example, modules may be stored in memory 8304 of FIG. 8, and these modules may provide instructions so that when the instructions of a module are executed by respective first network node processing circuitry 7220, first network node 8300 performs respective operations of the flow chart.

Operations of a second network node can be performed by the RAN node 8300 of FIG. 8. Operations of the second network node (implemented using the structure of FIG. 8) have been discussed with reference to the flow chart of FIG. 4 according to some embodiments of the present disclosure. For example, modules may be stored in memory 8304 of FIG. 8, and these modules may provide instructions so that when the instructions of a module are executed by respective second network node processing circuitry 7220, second network node 8300 performs respective operations of the flow chart.

Operations of a first network node operating as a master node can be performed by the RAN node 8300 of FIG. 8. Operations of the first network node (implemented using the structure of FIG. 8) have been discussed with reference to the flow chart of FIG. 5 according to some embodiments of the present disclosure. For example, modules may be stored in memory 8304 of FIG. 8, and these modules may provide instructions so that when the instructions of a module are executed by respective first network node processing circuitry 7220, first network node 8300 performs respective operations of the flow chart.

The operations of the flow charts 3-5 can be performed by a Core Network CN node 8300 of FIG. 8. Operations of the Core Network CN node 8300 (implemented using the structure of FIG. 8) have been discussed with reference to the flow charts of FIGS. 3-5 according to some embodiments of the present disclosure. For example, modules may be stored in memory 8304 of FIG. 8, and these modules may provide instructions so that when the instructions of a module are executed by respective CN node processing circuitry 8302, CN node 8300 performs respective operations of the respective flow charts.

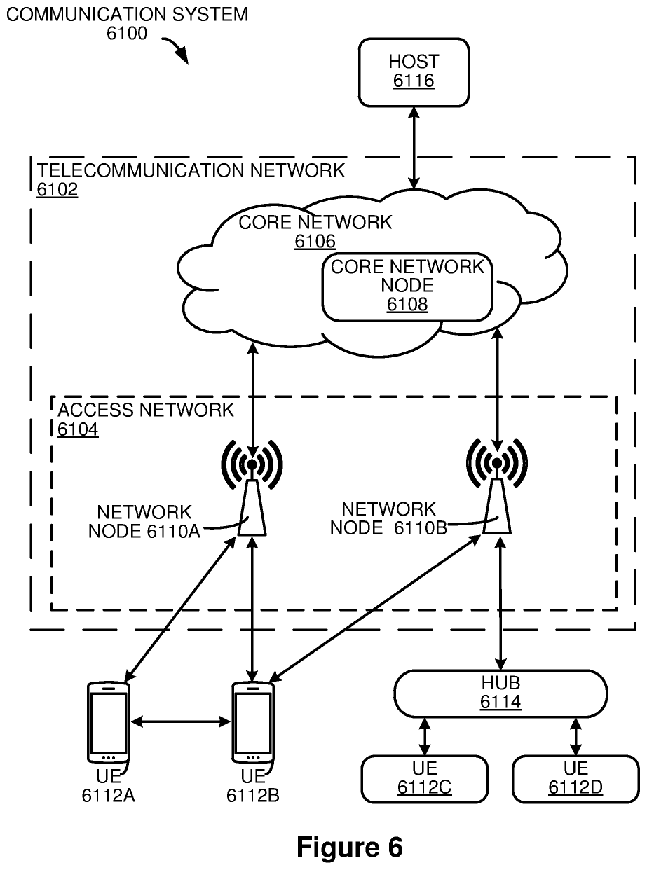

FIG. 6 shows an example of a communication system 6100 in accordance with some embodiments.

In the example, the communication system 6100 includes a telecommunication network 6102 that includes an access network 6104, such as a radio access network (RAN), and a core network 6106, which includes one or more core network nodes 6108. The access network 6104 includes one or more access network nodes, such as network nodes 6110a and 6110b (one or more of which may be generally referred to as network nodes 6110), or any other similar 3rd Generation Partnership Project (3GPP) access node or non-3GPP access point. The network nodes 6110 facilitate direct or indirect connection of user equipment (UE), such as by connecting UEs 6112a, 6112b, 6112c, and 6112d (one or more of which may be generally referred to as UEs 6112) to the core network 6106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 6100 may include any number of wired or wireless networks, network nodes, UEs, and/or any other components or systems that may facilitate or participate in the communication of data and/or signals whether via wired or wireless connections. The communication system 6100 may include and/or interface with any type of communication, telecommunication, data, cellular, radio network, and/or other similar type of system.

The UEs 6112 may be any of a wide variety of communication devices, including wireless devices arranged, configured, and/or operable to communicate wirelessly with the network nodes 6110 and other communication devices. Similarly, the network nodes 6110 are arranged, capable, configured, and/or operable to communicate directly or indirectly with the UEs 6112 and/or with other network nodes or equipment in the telecommunication network 6102 to enable and/or provide network access, such as wireless network access, and/or to perform other functions, such as administration in the telecommunication network 6102.

In the depicted example, the core network 6106 connects the network nodes 6110 to one or more hosts, such as host 6116. These connections may be direct or indirect via one or more intermediary networks or devices. In other examples, network nodes may be directly coupled to hosts. The core network 6106 includes one more core network nodes (e.g., core network node 6108) that are structured with hardware and software components. Features of these components may be substantially similar to those described with respect to the UEs, network nodes, and/or hosts, such that the descriptions thereof are generally applicable to the corresponding components of the core network node 6108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 6116 may be under the ownership or control of a service provider other than an operator or provider of the access network 6104 and/or the telecommunication network 6102, and may be operated by the service provider or on behalf of the service provider. The host 6116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 6100 of FIG. 6 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 6102 is a cellular network that implements 3GPP standardized features. Accordingly, the telecommunications network 6102 may support network slicing to provide different logical networks to different devices that are connected to the telecommunication network 6102. For example, the telecommunications network 6102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 6112 are configured to transmit and/or receive information without direct human interaction. For instance, a UE may be designed to transmit information to the access network 6104 on a predetermined schedule, when triggered by an internal or external event, or in response to requests from the access network 6104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 6114 communicates with the access network 6104 to facilitate indirect communication between one or more UEs (e.g., UE 6112c and/or 6112d) and network nodes (e.g., network node 6110b). In some examples, the hub 6114 may be a controller, router, content source and analytics, or any of the other communication devices described herein regarding UEs. For example, the hub 6114 may be a broadband router enabling access to the core network 6106 for the UEs. As another example, the hub 6114 may be a controller that sends commands or instructions to one or more actuators in the UEs. Commands or instructions may be received from the UEs, network nodes 6110, or by executable code, script, process, or other instructions in the hub 6114. As another example, the hub 6114 may be a data collector that acts as temporary storage for UE data and, in some embodiments, may perform analysis or other processing of the data. As another example, the hub 6114 may be a content source. For example, for a UE that is a VR headset, display, loudspeaker or other media delivery device, the hub 6114 may retrieve VR assets, video, audio, or other media or data related to sensory information via a network node, which the hub 6114 then provides to the UE either directly, after performing local processing, and/or after adding additional local content. In still another example, the hub 6114 acts as a proxy server or orchestrator for the UEs, in particular in if one or more of the UEs are low energy IoT devices.

The hub 6114 may have a constant/persistent or intermittent connection to the network node 6110b. The hub 6114 may also allow for a different communication scheme and/or schedule between the hub 6114 and UEs (e.g., UE 6112c and/or 6112d), and between the hub 6114 and the core network 6106. In other examples, the hub 6114 is connected to the core network 6106 and/or one or more UEs via a wired connection. Moreover, the hub 6114 may be configured to connect to an M2M service provider over the access network 6104 and/or to another UE over a direct connection. In some scenarios, UEs may establish a wireless connection with the network nodes 6110 while still connected via the hub 6114 via a wired or wireless connection. In some embodiments, the hub 6114 may be a dedicated hub—that is, a hub whose primary function is to route communications to/from the UEs from/to the network node 6110b. In other embodiments, the hub 6114 may be a non-dedicated hub—that is, a device which is capable of operating to route communications between the UEs and network node 6110b, but which is additionally capable of operating as a communication start and/or end point for certain data channels.

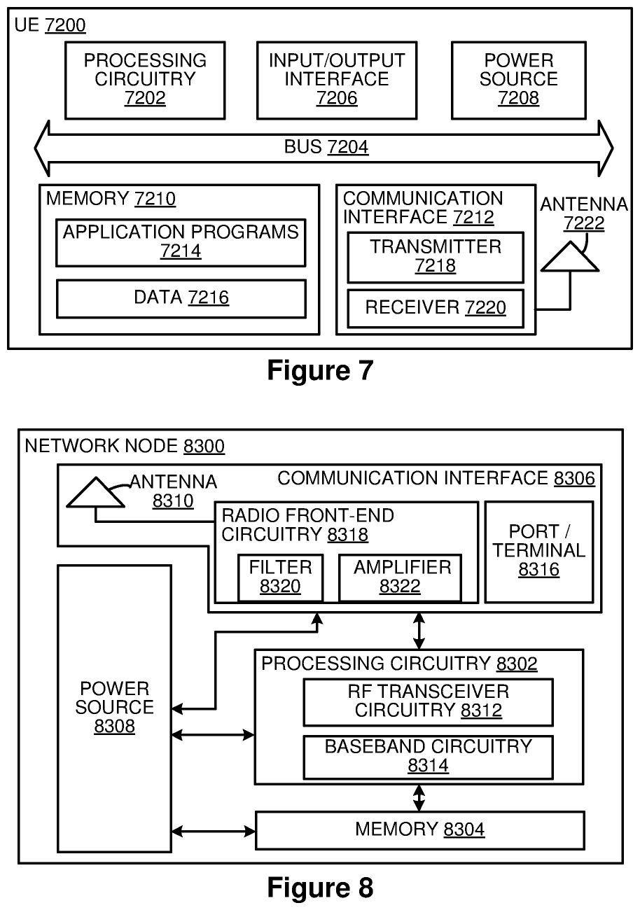

FIG. 7 shows a UE 7200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IOT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 7200 includes processing circuitry 7202 that is operatively coupled via a bus 7204 to an input/output interface 7206, a power source 7208, a memory 7210, a communication interface 7212, and/or any other component, or any combination thereof. Certain UEs may utilize all or a subset of the components shown in FIG. 7. The level of integration between the components may vary from one UE to another UE. Further, certain UEs may contain multiple instances of a component, such as multiple processors, memories, transceivers, transmitters, receivers, etc.

The processing circuitry 7202 is configured to process instructions and data and may be configured to implement any sequential state machine operative to execute instructions stored as machine-readable computer programs in the memory 7210. The processing circuitry 7202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 7202 may include multiple central processing units (CPUs).

In the example, the input/output interface 7206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 7200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 7208 is structured as a battery or battery pack. Other types of power sources, such as an external power source (e.g., an electricity outlet), photovoltaic device, or power cell, may be used. The power source 7208 may further include power circuitry for delivering power from the power source 7208 itself, and/or an external power source, to the various parts of the UE 7200 via input circuitry or an interface such as an electrical power cable. Delivering power may be, for example, for charging of the power source 7208. Power circuitry may perform any formatting, converting, or other modification to the power from the power source 7208 to make the power suitable for the respective components of the UE 7200 to which power is supplied.

The memory 7210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 7210 includes one or more application programs 7214, such as an operating system, web browser application, a widget, gadget engine, or other application, and corresponding data 7216. The memory 7210 may store, for use by the UE 7200, any of a variety of various operating systems or combinations of operating systems.

The memory 7210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 7210 may allow the UE 7200 to access instructions, application programs and the like, stored on transitory or non-transitory memory media, to off-load data, or to upload data. An article of manufacture, such as one utilizing a communication system may be tangibly embodied as or in the memory 7210, which may be or comprise a device-readable storage medium.

The processing circuitry 7202 may be configured to communicate with an access network or other network using the communication interface 7212. The communication interface 7212 may comprise one or more communication subsystems and may include or be communicatively coupled to an antenna 7222. The communication interface 7212 may include one or more transceivers used to communicate, such as by communicating with one or more remote transceivers of another device capable of wireless communication (e.g., another UE or a network node in an access network). Each transceiver may include a transmitter 7218 and/or a receiver 7220 appropriate to provide network communications (e.g., optical, electrical, frequency allocations, and so forth). Moreover, the transmitter 7218 and receiver 7220 may be coupled to one or more antennas (e.g., antenna 7222) and may share circuit components, software or firmware, or alternatively be implemented separately.

In the illustrated embodiment, communication functions of the communication interface 7212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 7212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IOT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 7200 shown in FIG. 7.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IOT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 8 shows a network node 8300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 8300 includes a processing circuitry 8302, a memory 8304, a communication interface 8306, and a power source 8308. The network node 8300 may be composed of multiple physically separate components (e.g., a NodeB component and a RNC component, or a BTS component and a BSC component, etc.), which may each have their own respective components. In certain scenarios in which the network node 8300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 8300 may be configured to support multiple radio access technologies (RATs). In such embodiments, some components may be duplicated (e.g., separate memory 8304 for different RATs) and some components may be reused (e.g., a same antenna 8310 may be shared by different RATs). The network node 8300 may also include multiple sets of the various illustrated components for different wireless technologies integrated into network node 8300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 8300.

The processing circuitry 8302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 8300 components, such as the memory 8304, to provide network node 8300 functionality.

In some embodiments, the processing circuitry 8302 includes a system on a chip (SOC). In some embodiments, the processing circuitry 8302 includes one or more of radio frequency (RF) transceiver circuitry 8312 and baseband processing circuitry 8314. In some embodiments, the radio frequency (RF) transceiver circuitry 8312 and the baseband processing circuitry 8314 may be on separate chips (or sets of chips), boards, or units, such as radio units and digital units. In alternative embodiments, part or all of RF transceiver circuitry 8312 and baseband processing circuitry 8314 may be on the same chip or set of chips, boards, or units.

The memory 8304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 8302. The memory 8304 may store any suitable instructions, data, or information, including a computer program, software, an application including one or more of logic, rules, code, tables, and/or other instructions capable of being executed by the processing circuitry 8302 and utilized by the network node 8300. The memory 8304 may be used to store any calculations made by the processing circuitry 8302 and/or any data received via the communication interface 8306. In some embodiments, the processing circuitry 8302 and memory 8304 is integrated.

The communication interface 8306 is used in wired or wireless communication of signaling and/or data between a network node, access network, and/or UE. As illustrated, the communication interface 8306 comprises port(s)/terminal(s) 8316 to send and receive data, for example to and from a network over a wired connection. The communication interface 8306 also includes radio front-end circuitry 8318 that may be coupled to, or in certain embodiments a part of, the antenna 8310. Radio front-end circuitry 8318 comprises filters 8320 and amplifiers 8322. The radio front-end circuitry 8318 may be connected to an antenna 8310 and processing circuitry 8302. The radio front-end circuitry may be configured to condition signals communicated between antenna 8310 and processing circuitry 8302. The radio front-end circuitry 8318 may receive digital data that is to be sent out to other network nodes or UEs via a wireless connection. The radio front-end circuitry 8318 may convert the digital data into a radio signal having the appropriate channel and bandwidth parameters using a combination of filters 8320 and/or amplifiers 8322. The radio signal may then be transmitted via the antenna 8310. Similarly, when receiving data, the antenna 8310 may collect radio signals which are then converted into digital data by the radio front-end circuitry 8318. The digital data may be passed to the processing circuitry 8302. In other embodiments, the communication interface may comprise different components and/or different combinations of components.

In certain alternative embodiments, the network node 8300 does not include separate radio front-end circuitry 8318, instead, the processing circuitry 8302 includes radio front-end circuitry and is connected to the antenna 8310. Similarly, in some embodiments, all or some of the RF transceiver circuitry 8312 is part of the communication interface 8306. In still other embodiments, the communication interface 8306 includes one or more ports or terminals 8316, the radio front-end circuitry 8318, and the RF transceiver circuitry 8312, as part of a radio unit (not shown), and the communication interface 8306 communicates with the baseband processing circuitry 8314, which is part of a digital unit (not shown).

The antenna 8310 may include one or more antennas, or antenna arrays, configured to send and/or receive wireless signals. The antenna 8310 may be coupled to the radio front-end circuitry 8318 and may be any type of antenna capable of transmitting and receiving data and/or signals wirelessly. In certain embodiments, the antenna 8310 is separate from the network node 8300 and connectable to the network node 8300 through an interface or port.

The antenna 8310, communication interface 8306, and/or the processing circuitry 8302 may be configured to perform any receiving operations and/or certain obtaining operations described herein as being performed by the network node. Any information, data and/or signals may be received from a UE, another network node and/or any other network equipment. Similarly, the antenna 8310, the communication interface 8306, and/or the processing circuitry 8302 may be configured to perform any transmitting operations described herein as being performed by the network node. Any information, data and/or signals may be transmitted to a UE, another network node and/or any other network equipment.

The power source 8308 provides power to the various components of network node 8300 in a form suitable for the respective components (e.g., at a voltage and current level needed for each respective component). The power source 8308 may further comprise, or be coupled to, power management circuitry to supply the components of the network node 8300 with power for performing the functionality described herein. For example, the network node 8300 may be connectable to an external power source (e.g., the power grid, an electricity outlet) via an input circuitry or interface such as an electrical cable, whereby the external power source supplies power to power circuitry of the power source 8308. As a further example, the power source 8308 may comprise a source of power in the form of a battery or battery pack which is connected to, or integrated in, power circuitry. The battery may provide backup power should the external power source fail.

Embodiments of the network node 8300 may include additional components beyond those shown in FIG. 8 for providing certain aspects of the network node's functionality, including any of the functionality described herein and/or any functionality necessary to support the subject matter described herein. For example, the network node 8300 may include user interface equipment to allow input of information into the network node 8300 and to allow output of information from the network node 8300. This may allow a user to perform diagnostic, maintenance, repair, and other administrative functions for the network node 8300.

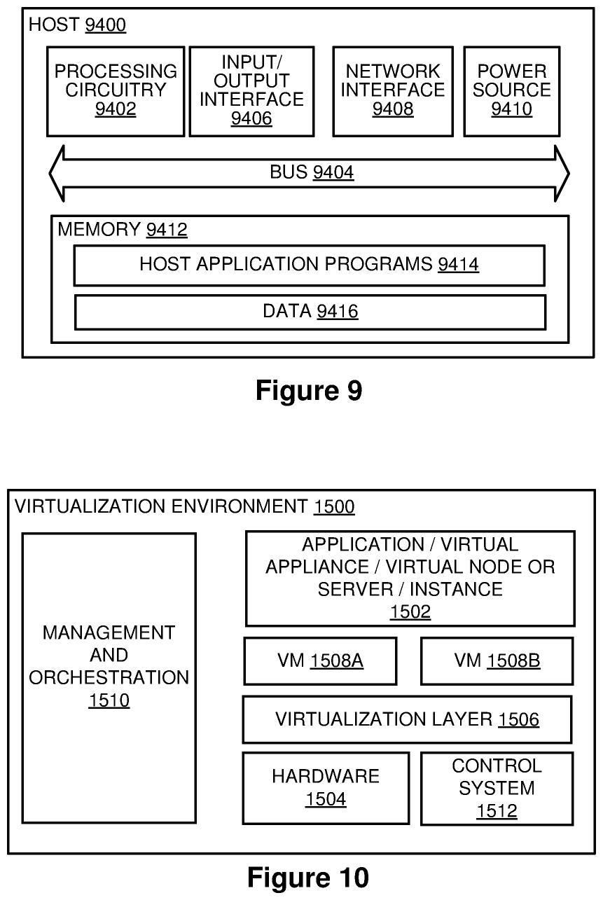

FIG. 9 is a block diagram of a host 9400, which may be an embodiment of the host 6116 of FIG. 6, in accordance with various aspects described herein. As used herein, the host 9400 may be or comprise various combinations hardware and/or software, including a standalone server, a blade server, a cloud-implemented server, a distributed server, a virtual machine, container, or processing resources in a server farm. The host 9400 may provide one or more services to one or more UEs.

The host 9400 includes processing circuitry 9402 that is operatively coupled via a bus 9404 to an input/output interface 9406, a network interface 9408, a power source 9410, and a memory 9412. Other components may be included in other embodiments. Features of these components may be substantially similar to those described with respect to the devices of previous figures, such as FIGS. 7-8, such that the descriptions thereof are generally applicable to the corresponding components of host 9400.

The memory 9412 may include one or more computer programs including one or more host application programs 9414 and data 9416, which may include user data, e.g., data generated by a UE for the host 9400 or data generated by the host 9400 for a UE. Embodiments of the host 9400 may utilize only a subset or all of the components shown. The host application programs 9414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 9414 may also provide for user authentication and licensing checks and may periodically report health, routes, and content availability to a central node, such as a device in or on the edge of a core network. Accordingly, the host 9400 may select and/or indicate a different host for over-the-top services for a UE. The host application programs 9414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 10 is a block diagram illustrating a virtualization environment 1500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1506 (also referred to as hypervisors or virtual machine monitors (VMMs)), provide VMs 1508a and 1508b (one or more of which may be generally referred to as VMs 1508), and/or perform any of the functions, features and/or benefits described in relation with some embodiments described herein. The virtualization layer 1506 may present a virtual operating platform that appears like networking hardware to the VMs 1508.

The VMs 1508 comprise virtual processing, virtual memory, virtual networking or interface and virtual storage, and may be run by a corresponding virtualization layer 1506. Different embodiments of the instance of a virtual appliance 1502 may be implemented on one or more of VMs 1508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1508 may be a software implementation of a physical machine that runs programs as if they were executing on a physical, non-virtualized machine. Each of the VMs 1508, and that part of hardware 1504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1508 on top of the hardware 1504 and corresponds to the application 1502.

Hardware 1504 may be implemented in a standalone network node with generic or specific components. Hardware 1504 may implement some functions via virtualization. Alternatively, hardware 1504 may be part of a larger cluster of hardware (e.g. such as in a data center or CPE) where many hardware nodes work together and are managed via management and orchestration 1510, which, among others, oversees lifecycle management of applications 1502. In some embodiments, hardware 1504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1512 which may alternatively be used for communication between hardware nodes and radio units.

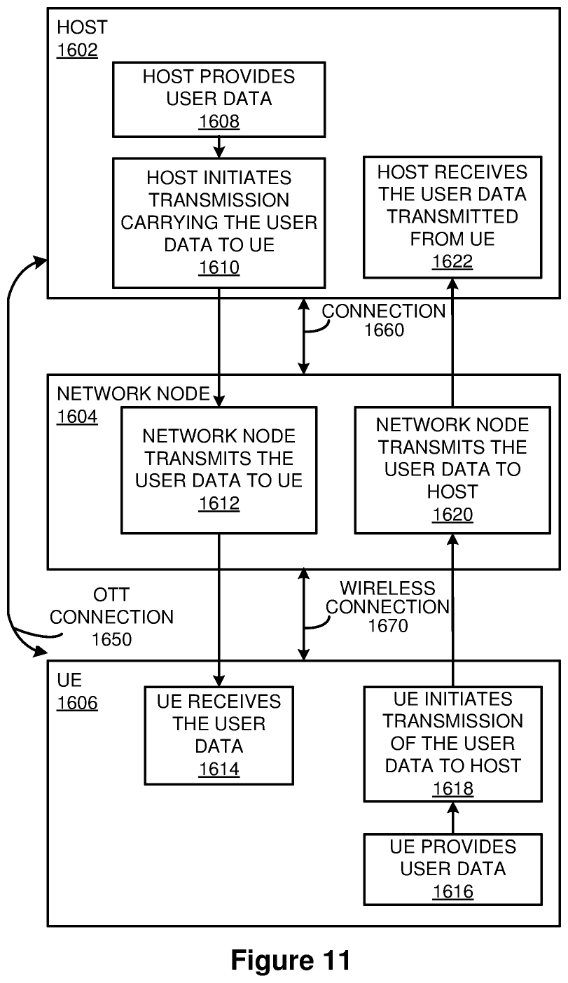

FIG. 11 shows a communication diagram of a host 1602 communicating via a network node 1604 with a UE 1606 over a partially wireless connection in accordance with some embodiments. Example implementations, in accordance with various embodiments, of the UE (such as a UE 6112a of FIG. 6 and/or UE 7200 of FIG. 7), network node (such as network node 6110a of FIG. 6 and/or network node 8300 of FIG. 8), and host (such as host 6116 of FIG. 6 and/or host 9400 of FIG. 9) discussed in the preceding paragraphs will now be described with reference to FIG. 9.

Like host 9400, embodiments of host 1602 include hardware, such as a communication interface, processing circuitry, and memory. The host 1602 also includes software, which is stored in or accessible by the host 1602 and executable by the processing circuitry. The software includes a host application that may be operable to provide a service to a remote user, such as the UE 1606 connecting via an over-the-top (OTT) connection 1650 extending between the UE 1606 and host 1602. In providing the service to the remote user, a host application may provide user data which is transmitted using the OTT connection 1650.

The network node 1604 includes hardware enabling it to communicate with the host 1602 and UE 1606. The connection 1660 may be direct or pass through a core network (like core network 6106 of FIG. 13) and/or one or more other intermediate networks, such as one or more public, private, or hosted networks. For example, an intermediate network may be a backbone network or the Internet.

The UE 1606 includes hardware and software, which is stored in or accessible by UE 1606 and executable by the UE's processing circuitry. The software includes a client application, such as a web browser or operator-specific “app” that may be operable to provide a service to a human or non-human user via UE 1606 with the support of the host 1602. In the host 1602, an executing host application may communicate with the executing client application via the OTT connection 1650 terminating at the UE 1606 and host 1602. In providing the service to the user, the UE's client application may receive request data from the host's host application and provide user data in response to the request data. The OTT connection 1650 may transfer both the request data and the user data. The UE's client application may interact with the user to generate the user data that it provides to the host application through the OTT connection 1650.

The OTT connection 1650 may extend via a connection 1660 between the host 1602 and the network node 1604 and via a wireless connection 1670 between the network node 1604 and the UE 1606 to provide the connection between the host 1602 and the UE 1606. The connection 1660 and wireless connection 1670, over which the OTT connection 1650 may be provided, have been drawn abstractly to illustrate the communication between the host 1602 and the UE 1606 via the network node 1604, without explicit reference to any intermediary devices and the precise routing of messages via these devices.

As an example of transmitting data via the OTT connection 1650, in step 1608, the host 1602 provides user data, which may be performed by executing a host application. In some embodiments, the user data is associated with a particular human user interacting with the UE 1606. In other embodiments, the user data is associated with a UE 1606 that shares data with the host 1602 without explicit human interaction. In step 1610, the host 1602 initiates a transmission carrying the user data towards the UE 1606. The host 1602 may initiate the transmission responsive to a request transmitted by the UE 1606. The request may be caused by human interaction with the UE 1606 or by operation of the client application executing on the UE 1606. The transmission may pass via the network node 1604, in accordance with the teachings of the embodiments described throughout this disclosure. Accordingly, in step 1612, the network node 1604 transmits to the UE 1606 the user data that was carried in the transmission that the host 1602 initiated, in accordance with the teachings of the embodiments described throughout this disclosure. In step 1614, the UE 1606 receives the user data carried in the transmission, which may be performed by a client application executed on the UE 1606 associated with the host application executed by the host 1602.

In some examples, the UE 1606 executes a client application which provides user data to the host 1602. The user data may be provided in reaction or response to the data received from the host 1602. Accordingly, in step 1616, the UE 1606 may provide user data, which may be performed by executing the client application. In providing the user data, the client application may further consider user input received from the user via an input/output interface of the UE 1606. Regardless of the specific manner in which the user data was provided, the UE 1606 initiates, in step 1618, transmission of the user data towards the host 1602 via the network node 1604. In step 1620, in accordance with the teachings of the embodiments described throughout this disclosure, the network node 1604 receives user data from the UE 1606 and initiates transmission of the received user data towards the host 1602. In step 1622, the host 1602 receives the user data carried in the transmission initiated by the UE 1606.

In an example scenario, factory status information may be collected and analyzed by the host 1602. As another example, the host 1602 may process audio and video data which may have been retrieved from a UE for use in creating maps. As another example, the host 1602 may collect and analyze real-time data to assist in controlling vehicle congestion (e.g., controlling traffic lights). As another example, the host 1602 may store surveillance video uploaded by a UE. As another example, the host 1602 may store or control access to media content such as video, audio, VR or AR which it can broadcast, multicast or unicast to UEs. As other examples, the host 1602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1650 between the host 1602 and UE 1606, in response to variations in the measurement results. The measurement procedure and/or the network functionality for reconfiguring the OTT connection may be implemented in software and hardware of the host 1602 and/or UE 1606. In some embodiments, sensors (not shown) may be deployed in or in association with other devices through which the OTT connection 1650 passes; the sensors may participate in the measurement procedure by supplying values of the monitored quantities exemplified above, or supplying values of other physical quantities from which software may compute or estimate the monitored quantities. The reconfiguring of the OTT connection 1650 may include message format, retransmission settings, preferred routing etc.; the reconfiguring need not directly alter the operation of the network node 1604. Such procedures and functionalities may be known and practiced in the art. In certain embodiments, measurements may involve proprietary UE signaling that facilitates measurements of throughput, propagation times, latency and the like, by the host 1602. The measurements may be implemented in that software causes messages to be transmitted, in particular empty or ‘dummy’ messages, using the OTT connection 1650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

A listing of Embodiments is provided below:

1. A method performed by a first network node to identify a network node that initiated a primary secondary cell, PSCell, change that results in generation of a report from a user equipment, UE, the method comprising:
signaling (300) a request to a second network node comprising a request for a PSCell change and a first indication related to the PSCell change, wherein the first indication indicates that the PSCell change is related (to?) one of the first network node initiating the PSCell change or the second network node initiating the PSCell change;
receiving (302) a response from the second network node that the PSCell change was successful;
receiving (304) a message from the second network node comprising the report; and
performing (306), based on the first indication, one of: (i) if the PSCell change was initiated by the first network node, analyzing the report to improve the PSCell change, and (ii) if the PSCell change was initiated by the second network node, forwarding the report to at least one additional network node.

2. The method of Embodiment 1, wherein the first network node is operating as a master node.

3. The method of any one of Embodiments 1 to 2, wherein the first indication is included in one of a message comprising a request for the PSCell change to a secondary node or a response to retrieve context from the UE.

4. The method of any one of Embodiments 1 to 2, the first network node is operating as a master node, the second network node is operating as a secondary node, and the first indication is included when the second network node initiated the PSCell change.

5. The method of any one of Embodiments 1 to 2, wherein the first network node is operating as a master node, the second network node is operating as a secondary node, and the first indication is included in at least one of (i) a master node mobility information, (ii) a secondary node mobility information, or (iii) a secondary node addition message and a response to retrieve context from the UE, and wherein the mobility information comprises the first indication that identifies whether the PSCell change was master node initiated or secondary node initiated.

6. The method of Embodiment 1, wherein the first network node is operating as a source master node, the second network node is operating as a target secondary node, the signaling (300) the first indication is signaled responsive to receiving a second indication from a third network node comprising a source secondary node, and wherein the second indication includes identification of the initiator of secondary node change and/or a mobility information of the secondary node change.

7. The method of Embodiment 6, wherein responsive to the received second indication, the first network node signals the first indication to the second network node and the first indication includes the identification of the initiator of secondary node change and/or the mobility information of the secondary node change.

8. The method of Embodiment 1, wherein the first network node is operating as a source master node, the second network node is operating as a target master node, and the first indication includes identification of the initiator of secondary node change and/or a mobility information of the initiator of the secondary node change.

9. The method of any one of Embodiments 1 to 8, wherein the signaling (300) the first indication is subject to the UE being configured with a configuration of the report by the network node that initiated the PSCell change.

10. The method of any one of Embodiments 1 to 2, wherein the first network node is operating as a master node, the second network node is operating as a secondary network node, the report comprises the first indicator, and first indicator is included when the report is related to the secondary network node initiating the PSCell change.

11. The method of any one of Embodiments 1 to 2, wherein the message from the second network node comprising the report further comprises at least one of (i) a master node mobility information, (ii) a secondary node mobility information, and wherein the mobility information comprises information to identify whether the PSCell change was master node initiated or secondary node initiated.

12. The method of any one of Embodiments 1 to 2, wherein the report comprises information that the report is linked to a master node initiated PSCell change or an SN initiated PSCell change.

13. A method performed by a second network node to identify a network node that initiated a primary secondary cell, PSCell, change that results in generation of a report from a user equipment, UE, the method comprising:
receiving (400) a request from a first network node, the request comprising a request for a PSCell change and a first indication related to the PSCell change, wherein the first indication indicates that the PSCell change is related one of the first network node initiating the PSCell change or the second network node initiating the PSCell change;
sending (402) a response to the second network node that the PSCell change was successful; and
sending (404) a message to the first network node comprising the report.

14. The method of Embodiment 13, wherein the second network node is operating as one of a secondary node and a node that performs re-establishment after a radio link failure, RLF.

15. The method of any one of Embodiments 13 to 14, wherein the first network node is operating as a master node for the PSCell change.

16. The method of any one of Embodiments 13 to 15, wherein first network node is operating as a master node, the second network node is operating as a secondary node, and the first indicator is received in a case of a secondary node initiated PSCell change.

17. The method of any one of Embodiments 13 to 16, wherein the first network node is operating as a master node, the second network node is operating as a secondary node, and wherein the receiving (404) a request further includes at least one of (i) a master node mobility information, and (ii) a secondary node mobility information, and wherein the mobility information comprises the first indication that identifies whether the PSCell change was master node initiated or secondary node initiated.

18. The method of Embodiment 13, wherein the first network node is operating as a master node, the second network node is operating as a secondary network node, the report comprises the first indicator, and first indicator is included when the report is related to the secondary network node initiating the PSCell change.

19. The method of Embodiment 13, wherein the message to the first network node comprising the report further comprises at least one of (i) a master node mobility information, (ii) a secondary node mobility information, and wherein the mobility information comprises information to identify whether the PSCell change was master node initiated or secondary node initiated.

20. The method of Embodiment 13, wherein the report comprises information that the report is linked to a master node initiated PSCell change or a secondary node initiated PSCell change.

21. A method performed by a first network node operating as a master node for a user equipment, UE, to identify whether a primary secondary cell, PSCell, change that results in generation of a report from the UE was initiated by the master node or a secondary node, the method comprising:
signaling (500) an identifier to the UE, the identifier comprising an index to retrieve a portion of context of the UE comprising that the PSCell change is associated with one of the master node initiating the PSCell change or the secondary node initiating the PSCell change;
storing (502), at a release of the UE, (i) the portion of a context of the UE related to a PSCell change, and (ii) the identifier;
receiving (504) a report from the UE or another network node, the report comprising the identifier;
identifying (506), based on the identifier, whether the report was generated after the master node initiated PSCell change or the secondary node PSCell change; and
performing (508), based on the identifier, one of: (i) if the PSCell change was initiated by the master node, analyzing the report to improve the PSCell change, and (ii) if the PSCell change was initiated by a secondary node, forwarding the report to at least one of a source master node and a target secondary node.

22. The method of Embodiment 21, wherein the signaling the identifier comprises at least one of: (i) signaled at dual connectivity setup, (ii) signaled as an inactive-radio network temporary identifier, I-RNTI, and (iii) signaled as a portion of the I-RNTI.

23. The method of any one of Embodiments 21 to 22, wherein the signaling further comprises a configuration for the UE to collect the report.

24. A first network node (QQ300) configured to identify a network node that initiated a primary secondary cell, PSCell, change that results in generation of a report from a user equipment, UE, the first network node comprising:
processing circuitry (QQ302);
memory (QQ304) coupled with the processing circuitry, wherein the memory includes instructions that when executed by the processing circuitry causes the first network node to perform operations comprising:
signal a request to a second network node comprising a request for a PSCell change and a first indication related to the PSCell change, wherein the first indication indicates that the PSCell change is related one of the first network node initiating the PSCell change or the second network node initiating the PSCell change;
receive a response from the second network node that the PSCell change was successful;
receive a message from the second network node comprising the report; and
perform, based on the first indication, one of: (i) if the PSCell change was initiated by the first network node, analyzing the report to improve the PSCell change, and (ii) if the PSCell change was initiated by the second network node, forwarding the report to at least one additional network node.

25. The first network node of Embodiment 24, wherein the memory includes instructions that when executed by the processing circuitry causes the first network node to perform further operations comprising any of the operations of any one of Embodiments 2 to 12.

26. A first network node (QQ300) configured to identify a network node that initiated a primary secondary cell, PSCell, change that results in generation of a report from a user equipment, UE, the first network node adapted to perform operations comprising:
signal a request to a second network node comprising a request for a PSCell change and a first indication related to the PSCell change, wherein the first indication indicates that the PSCell change is related one of the first network node initiating the PSCell change or the second network node initiating the PSCell change;
receive a response from the second network node that the PSCell change was successful;
receive a message from the second network node comprising the report; and
perform, based on the first indication, one of: (i) if the PSCell change was initiated by the first network node, analyzing the report to improve the PSCell change, and (ii) if the PSCell change was initiated by the second network node, forwarding the report to at least one additional network node.

27. The first network node of Embodiment 26 adapted to perform further operations according to any one of Embodiments 2 to 12.

28. A computer program comprising program code to be executed by processing circuitry (QQ302) of a first network node (QQ300) configured to identify a network node that initiated a primary secondary cell, PSCell, change that results in generation of a report from a user equipment, UE, whereby execution of the program code causes the first network node to perform operations comprising:
signal a request to a second network node comprising a request for a PSCell change and a first indication related to the PSCell change, wherein the first indication indicates that the PSCell change is related one of the first network node initiating the PSCell change or the second network node initiating the PSCell change;
receive a response from the second network node that the PSCell change was successful;
receive a message from the second network node comprising the report; and
perform, based on the first indication, one of: (i) if the PSCell change was initiated by the first network node, analyzing the report to improve the PSCell change, and (ii) if the PSCell change was initiated by the second network node, forwarding the report to at least one additional network node.

29. The computer program of Embodiment 28, whereby execution of the program code causes the first network node to perform operations according to any one of Embodiments 2 to 12.

30. A computer program product comprising a non-transitory storage medium (QQ304) including program code to be executed by processing circuitry (QQ302) of a first network node (QQ300) configured to identify a network node that initiated a primary secondary cell, PSCell, change that results in generation of a report from a user equipment, UE, whereby execution of the program code causes the first network node to perform operations comprising:
signal a request to a second network node comprising a request for a PSCell change and a first indication related to the PSCell change, wherein the first indication indicates that the PSCell change is related one of the first network node initiating the PSCell change or the second network node initiating the PSCell change;
receive a response from the second network node that the PSCell change was successful;
receive a message from the second network node comprising the report; and
perform, based on the first indication, one of: (i) if the PSCell change was initiated by the first network node, analyzing the report to improve the PSCell change, and (ii) if the PSCell change was initiated by the second network node, forwarding the report to at least one additional network node.

31. The computer program product of Embodiment 30, whereby execution of the program code causes the first network node to perform operations according to any one of Embodiments 2 to 12.

32. A second network node (QQ300) configured to identify a network node that initiated a primary secondary cell, PSCell, change that results in generation of a report from a user equipment, UE, the second network node comprising:
processing circuitry (QQ302);
memory (QQ304) coupled with the processing circuitry, wherein the memory includes instructions that when executed by the processing circuitry causes the second network node to perform operations comprising:
receive a request from a first network node, the request comprising a request for a PSCell change and a first indication related to the PSCell change, wherein the first indication indicates that the PSCell change is related one of the first network node initiating the PSCell change or the second network node initiating the PSCell change;
send a response to the second network node that the PSCell change was successful; and
send a message to the first network node comprising the report.

33. The second network node of Embodiment 32, wherein the memory includes instructions that when executed by the processing circuitry causes the second network node to perform further operations comprising any of the operations of any one of Embodiments 14 to 20.

34. A second network node (QQ300) configured to identify a network node that initiated a primary secondary cell, PSCell, change that results in generation of a report from a user equipment, UE, the second network node adapted to perform operations comprising:
receive a request from a first network node, the request comprising a request for a PSCell change and a first indication related to the PSCell change, wherein the first indication indicates that the PSCell change is related one of the first network node initiating the PSCell change or the second network node initiating the PSCell change;
send a response to the second network node that the PSCell change was successful; and
send a message to the first network node comprising the report.

35. The first network node of Embodiment 34 adapted to perform further operations according to any one of Embodiments 14 to 20.

36. A computer program comprising program code to be executed by processing circuitry (QQ302) of a second network node (QQ300) configured to identify a network node that initiated a primary secondary cell, PSCell, change that results in generation of a report from a user equipment, UE, whereby execution of the program code causes the first network node to perform operations comprising:
receive a request from a first network node, the request comprising a request for a PSCell change and a first indication related to the PSCell change, wherein the first indication indicates that the PSCell change is related one of the first network node initiating the PSCell change or the second network node initiating the PSCell change;
send a response to the second network node that the PSCell change was successful; and
send a message to the first network node comprising the report.

37. The computer program of Embodiment 36, whereby execution of the program code causes the second network node to perform operations according to any one of Embodiments 14 to 20.

38. A computer program product comprising a non-transitory storage medium (QQ304) including program code to be executed by processing circuitry (QQ302) of a second network node (QQ300) configured to identify a network node that initiated a primary secondary cell, PSCell, change that results in generation of a report from a user equipment, UE, whereby execution of the program code causes the second network node to perform operations comprising:
receive a request from a first network node, the request comprising a request for a PSCell change and a first indication related to the PSCell change, wherein the first indication indicates that the PSCell change is related one of the first network node initiating the PSCell change or the second network node initiating the PSCell change;
send a response to the second network node that the PSCell change was successful; and
send a message to the first network node comprising the report.

39. The computer program product of Embodiment 33, whereby execution of the program code causes the second network node to perform operations according to any one of Embodiments 14 to 20.

40. A first network node (QQ300) operating as a master node for a user equipment, UE, to identify whether a primary secondary cell, PSCell, change that results in generation of a report from the UE was initiated by the master node or a secondary node, the first network node comprising:
processing circuitry (QQ302);
memory (QQ304) coupled with the processing circuitry, wherein the memory includes instructions that when executed by the processing circuitry causes the first network node to perform operations comprising:
signal an identifier to the UE, the identifier comprising an index to retrieve a portion of context of the UE comprising that the PSCell change is associated with one of the master node initiating the PSCell change or the secondary node initiating the PSCell change;
store, at a release of the UE, (i) the portion of a context of the UE related to a PSCell change, and (ii) the identifier;
receive a report from the UE or another network node, the report comprising the identifier;
identify, based on the identifier, whether the report was generated after the master node initiated PSCell change or the secondary node PSCell change; and
perform, based on the identifier, one of: (i) if the PSCell change was initiated by the master node, analyzing the report to improve the PSCell change, and (ii) if the PSCell change was initiated by a secondary node, forwarding the report to at least one of a source master node and a target secondary node.

41. The first network node of Embodiment 40, wherein the memory includes instructions that when executed by the processing circuitry causes the first network node to perform further operations comprising any of the operations of any one of Embodiments 22 to 23.

42. A first network node (QQ300) operating as a master node for a user equipment, UE, to identify whether a primary secondary cell, PSCell, change that results in generation of a report from the UE was initiated by the master node or a secondary node, the first network node adapted to perform operations comprising:
signal an identifier to the UE, the identifier comprising an index to retrieve a portion of context of the UE comprising that the PSCell change is associated with one of the master node initiating the PSCell change or the secondary node initiating the PSCell change;
store, at a release of the UE, (i) the portion of a context of the UE related to a PSCell change, and (ii) the identifier;
receive a report from the UE or another network node, the report comprising the identifier;
identify, based on the identifier, whether the report was generated after the master node initiated PSCell change or the secondary node PSCell change; and
perform, based on the identifier, one of: (i) if the PSCell change was initiated by the master node, analyzing the report to improve the PSCell change, and (ii) if the PSCell change was initiated by a secondary node, forwarding the report to at least one of a source master node and a target secondary node.

43. The first network node of Embodiment 42 adapted to perform further operations according to any one of Embodiments 22 to 23.

44. A computer program comprising program code to be executed by processing circuitry (QQ302) of a first network node (QQ300) operating as a master node for a user equipment, UE, to identify whether a primary secondary cell, PSCell, change that results in generation of a report from the UE was initiated by the master node or a secondary node, whereby execution of the program code causes the first network node to perform operations comprising:
signal an identifier to the UE, the identifier comprising an index to retrieve a portion of context of the UE comprising that the PSCell change is associated with one of the master node initiating the PSCell change or the secondary node initiating the PSCell change;
store, at a release of the UE, (i) the portion of a context of the UE related to a PSCell change, and (ii) the identifier;
receive a report from the UE or another network node, the report comprising the identifier;
identify, based on the identifier, whether the report was generated after the master node initiated PSCell change or the secondary node PSCell change; and
perform, based on the identifier, one of: (i) if the PSCell change was initiated by the master node, analyzing the report to improve the PSCell change, and (ii) if the PSCell change was initiated by a secondary node, forwarding the report to at least one of a source master node and a target secondary node.

45. The computer program of Embodiment 44, whereby execution of the program code causes the first network node to perform operations according to any one of Embodiments 22 to 23.

46. A computer program product comprising a non-transitory storage medium (QQ304) including program code to be executed by processing circuitry (QQ302) of a first network node (QQ300) operating as a master node for a user equipment, UE, to identify whether a primary secondary cell, PSCell, change that results in generation of a report from the UE was initiated by the master node or a secondary node, whereby execution of the program code causes the first network node to perform operations comprising:
signal an identifier to the UE, the identifier comprising an index to retrieve a portion of context of the UE comprising that the PSCell change is associated with one of the master node initiating the PSCell change or the secondary node initiating the PSCell change;
store, at a release of the UE, (i) the portion of a context of the UE related to a PSCell change, and (ii) the identifier;
receive a report from the UE or another network node, the report comprising the identifier;
identify, based on the identifier, whether the report was generated after the master node initiated PSCell change or the secondary node PSCell change; and
perform, based on the identifier, one of: (i) if the PSCell change was initiated by the master node, analyzing the report to improve the PSCell change, and (ii) if the PSCell change was initiated by a secondary node, forwarding the report to at least one of a source master node and a target secondary node.

47. The computer program product of Embodiment 36, whereby execution of the program code causes the first network node to perform operations according to any one of Embodiments 22 to 23.

1. A method performed by a first network node to identify a network node that initiated a primary secondary cell, PSCell, change that results in generation of a report from a user equipment, UE, the method comprising:
signaling a request to a second network node comprising a request for a PSCell change comprising a PSCell addition or a secondary node, SN, addition and a first indication related to the PSCell change, wherein the first indication indicates that the PSCell change is related one of the first network node initiating the PSCell change or the second network node initiating the PSCell change;
receiving a message from the second network node comprising the report; and
performing, based on the first indication, one of: (i) if the PSCell change was initiated by the first network node, analyzing the report to improve the PSCell change, and (ii) if the PSCell change was initiated by the second network node, forwarding the report to at least one additional network node.

2. The method of claim 1, further comprising:
receiving a response from the second network node that the PSCell change was successful.

3. The method of claim 1, wherein the first network node is operating as a master node.

4. The method of claim 1, wherein the first indication is included in one of a message comprising a request for the PSCell change to a secondary node or a response to retrieve context from the UE.

5. The method of claim 1, the first network node is operating as a master node, the second network node is operating as a secondary node, and the first indication is included when the second network node initiated the PSCell change.

6. The method of claim 1, wherein the first network node is operating as a master node, the second network node is operating as a secondary node, and the first indication is included in at least one of (i) a master node mobility information, (ii) a secondary node mobility information, or (iii) a secondary node addition message and a response to retrieve context from the UE, and wherein the mobility information comprises the first indication that identifies whether the PSCell change was master node initiated or secondary node initiated.

7. The method of claim 1, wherein the first network node is operating as a source master node, the second network node is operating as a target secondary node, the signaling the first indication is signaled responsive to receiving a second indication from a third network node comprising a source secondary node, and wherein the second indication includes identification of the initiator of secondary node change and/or a mobility information of the secondary node change.

8. The method of claim 7, wherein responsive to the received second indication, the first network node signals the first indication to the second network node and the first indication includes the identification of the initiator of secondary node change and/or the mobility information of the secondary node change.

9. The method of claim 1, wherein the first network node is operating as a source master node, the second network node is operating as a target master node, and the first indication includes identification of the initiator of secondary node change and/or a mobility information of the initiator of the secondary node change.

10. The method of claim 1, wherein the signaling the first indication is subject to the UE being configured with a configuration of the report by the network node that initiated the PSCell change.

11. The method of claim 1, wherein the first network node is operating as a master node, the second network node is operating as a secondary network node, the report comprises the first indicator, and first indicator is included when the report is related to the secondary network node initiating the PSCell change.

12. The method of claim 1, wherein the message from the second network node comprising the report further comprises at least one of (i) a master node mobility information, (ii) a secondary node mobility information, and wherein the mobility information comprises information to identify whether the PSCell change was master node initiated or secondary node initiated.

13. The method of claim 1, wherein the report comprises information that the report is linked to a master node initiated PSCell change or an SN initiated PSCell change.

14. A method performed by a second network node to identify a network node that initiated a primary secondary cell, PSCell, change that results in generation of a report from a user equipment, UE, the method comprising:
receiving a request from a first network node, the request comprising a request for a PSCell change and a first indication related to the PSCell change, wherein the first indication indicates that the PSCell change is related one of the first network node initiating the PSCell change or the second network node initiating the PSCell change; and
sending a message to the first network node comprising the report and the first indication.

15. The method of claim 14, further comprising:
sending a response to the second network node that the PSCell change was successful.

16. The method of claim 14, wherein the second network node is operating as one of a secondary node and a node that performs re-establishment after a radio link failure, RLF.

17. The method of claim 14, wherein the first network node is operating as a master node for the PSCell change.

18. The method of claim 14, wherein first network node is operating as a master node, the second network node is operating as a secondary node, and the first indication is received in a case of a secondary node initiated PSCell change.

19. The method of claim 14, wherein the first network node is operating as a master node, the second network node is operating as a secondary node, and wherein the receiving a request further includes at least one of (i) a master node mobility information, and (ii) a secondary node mobility information, and wherein the mobility information comprises the first indication that identifies whether the PSCell change was master node initiated or secondary node initiated.

20.-22. (canceled)

23. A method performed by a first network node operating as a master node for a user equipment, UE, to identify whether a primary secondary cell, PSCell, change that results in generation of a report from the UE was initiated by the master node or a secondary node, the method comprising:
signaling an identifier to the UE, the identifier comprising an index to retrieve a portion of context of the UE comprising that the PSCell change is associated with one of the master node initiating the PSCell change or the secondary node initiating the PSCell change;
storing, at a release of the UE, (i) the portion of a context of the UE related to a PSCell change, and (ii) the identifier;
receiving a report from the UE or another network node, the report comprising the identifier;
identifying, based on the identifier, whether the report was generated after the master node initiated PSCell change or the secondary node PSCell change; and
performing, based on the identifier, one of: (i) if the PSCell change was initiated by the master node, analyzing the report to improve the PSCell change, and (ii) if the PSCell change was initiated by a secondary node, forwarding the report to at least one of a source master node and a target secondary node.

24.-49. (canceled)
